(19) United States
(12) Patent Application Publication
(10) Pub. No.: US 2009/0177888 A1
(43) Pub. Date: Jul. 9, 2009

(54) INFORMATION PROCESSING DEVICE, KEY SETTING METHOD, AND PROGRAM

(76) Inventors: Tomoyuki ASANO, Kanagawa (JP); Masafumi Kusakawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/266,692

(22) Filed: Nov. 7, 2008

(30) Foreign Application Priority Data
Nov. 9, 2007 (JP) 2007-292587

(51) Int. Cl. H04L 9/32; G06F 15/173

(52) U.S. Cl. 713/171; 709/241

(57) ABSTRACT

There is provided an information processing device including an identifier setting unit for setting an identifier to a set of terminal devices corresponding to each node of a tree structure, and a key setting unit for setting a key distributed to the terminal device based on the identifier, wherein the identifier setting unit includes a first identifier indicating the set of terminal devices corresponding to each node, and sets the identifier so as to further include a second identifier showing a correspondence relation between plurality of subsets when the set includes a plurality of subsets.

### CROSS REFERENCES TO RELATED APPLICATIONS

The present invention contains subjected matter related to Japanese Patent Application JP 2007-292587 filed in the Japan Patent Office on Nov. 9, 2007, the entire contents of which being incorporated herein by reference.

### BACKGROUND OF THE INVENTION

1. Field of the Invention

The present invention relates to an information processing device, a key setting method, and a program.

2. Description of the Related Art

In recent years, with wide spread use of information equipments such as personal computer (hereinafter referred to as PC), portable telephone, and digital household electronics, a technique related to communication between such information equipments has been greatly advancing. A content distribution service for distributing contents such as music and video to such information equipments using broad band network and the like is also being widely developed. For instance, pay broadcast using CATV (Community Antenna TeleVision), satellite broadcast, or Internet, content distribution using physical media such as CD (Compact Disc) or DVD (Digital Versatile Disc) are being developed for content distribution service.

A viewing contract is made in advance between the provider (hereinafter referred to as system manager) and the viewer when such content distribution service is provided. It is desirable that only the contractor acquires the content based on the viewing contract. The system manager thus encrypts and then distributes the content, where a key for decrypting the content is given to the contractor in advance. Only the viewer who has made the viewing contract then can decrypt and view the content.

As one example of a content distribution system, a technique referred to as broadcast encryption system is known. The broadcast encryption system is a system of dividing a contractor set representing the entire contractor to a plurality of subsets after corresponding each contractor to an element of a predetermined set, and distributing a head h such that only the contractor belonging to a specific subset can acquire a content key mek. Through the use of such system, the system manager can specify and eliminate a specific contractor from the contractors who can view the content. Such technique can be referenced from Nuttapong Attrapadung and Hideki Imai, “Subset Incremental Chain Based Broadcast Encryption with Shorter Cipher text”, The 28th Symposium on Information Theory and Its Applications (SITA2005) and the like.

### SUMMARY OF THE INVENTION

Compared to the content distribution system (hereinafter referred to as AI system) described in the above document, a first modified system (hereinafter referred to as RS system) capable of reducing the amount of memory for each terminal device to hold a key a second modified system (hereinafter referred to as RC system) capable of reducing the amount of calculation for each terminal device to generate a content key, and a third modified system (hereinafter referred to as RCS system) capable of reducing the amount of memory and the amount of calculation have been developed and filed to the Japanese Patent Office (RS system: Japanese Patent Application No. 2006-310182, RC system: Japanese Patent Application No. 2006-310213, RCS system: Japanese Patent Application No. 2006-310226). However, the broadcast encryption system represented by such systems is an encryption technique of a common key system in which the transmitter and each contractor share a common key, and it is thus difficult to apply to a case where the transmitter desires to distribute a content encrypted with a public key system in which a private key of each contractor may not be known.

The present invention addresses the above-identified, and other problems associated with the methods of the related art. It is desirable to provide a newly and improved information processing device, a key setting method, and a program capable of realizing key distribution of a broadcast encryption system extended to a public key encryption system.

In order to solve the above issue, according to an embodiment of the present invention, there is provide an information processing device including an identifier setting unit for setting an identifier to a set of terminal devices corresponding to each node of a tree structure, and a key setting unit for setting a key distributed to the terminal device based on the identifier. The identifier setting unit may include a first identifier indicating the set of terminal devices corresponding to each node, and set the identifier so as to further include a second identifier showing a correspondence relation between plurality of subsets when the set includes a plurality of subsets.

The information processing device may further include a public information setting unit for setting public information including information of a predetermined multiplicative group, information of bilinear mapping defined by the multiplicative group, and information of a plurality of generators belonging to the multiplicative group, and publicized to the terminal device. The key setting unit may set a key corresponding to the first identifier and a key corresponding to each subset based on a predetermined parameter including the public information.

The information processing device may further include a path information acquiring unit for acquiring path information defined with a correspondence relationship between each subset for every set based on a predetermined system, and showing a path connecting one subset and another subset according to the correspondence relationship. The identifier setting unit may set the second identifier based on the path information acquired by the path information acquiring unit.

The information processing device may further include a path information acquiring unit for acquiring path information defined with a correspondence relationship between each subset for every set based on a predetermined system, and showing a path connecting one subset and another subset according to the correspondence relationship, and a path information changing unit for changing the path information acquired by the path information acquiring unit so that a path length between each subset becomes long. The identifier setting unit may set the second identifier based on the path information changed by the path information changing unit.

The information processing device may further include a path information acquiring unit for acquiring path information defined with a correspondence relationship between each subset for every set based on a predetermined system, and showing a path connecting one subset and another subset according to the correspondence relationship, and a path information changing unit for changing the path information acquired by the path information acquiring unit so that a path length between each subset becomes long, and changing the correspondence relationship between the subsets of relatively short path length contained in the changed path information to a correspondence relationship of shorter path length. The identifier setting unit may set the second identifier based on the path information changed by the path information changing unit.

The information processing device may further include a path information acquiring unit for acquiring path information defined with a correspondence relationship between each subset for every set based on a predetermined system, and showing a path connecting one subset and another subset according to the correspondence relationship, and a path information changing unit for changing the path information acquired by the path information acquiring unit so that a path length between each subset becomes short. The identifier setting unit may set the second identifier based on the path information changed by the path information changing unit.

In order to solve the above issue, according to another embodiment of the present invention, there is provided a key setting method in a key distribution system including a plurality of terminal devices. The key setting method includes the steps of: setting an identifier to a set of terminal devices corresponding to each node of a tree structure; and setting a key distributed to the terminal device based on the identifier. In the identifier setting step, a first identifier indicating the set of terminal devices corresponding to each node is included, and the identifier is set so that a second identifier showing a correspondence relation between plurality of subsets is further included when the set is configured by a plurality of subsets.

In order to solve the above issue, according to another embodiment of the present invention, there is provided a program for causing a computer to realize a key setting method in a key distribution system including a plurality of terminal devices. The program causes the computer to realize identifier setting function of setting an identifier to a set of terminal devices corresponding to each node of a tree structure, and key setting function of setting a key distributed to the terminal device based on the identifier, where the identifier setting function is a function of setting the identifier such that a first identifier indicating the set of terminal devices corresponding to each node is included, and a second identifier showing a correspondence relation between plurality of subsets is further included when the set is configured by a plurality of subsets.

Through the application of the above device, method, and program, the key distribution technique of the broadcast encryption system can be extended to the public key encryption system, and the application range of the broadcast encryption system such as sharing of encrypted files can be extended and at the same time the convenience of the user can be greatly enhanced. The number of keys to be held by each terminal device, the amount of calculation for key generation, or the amount of communication for key distribution can be reduced by devising the selecting method or the generation method of the path information defining the correspondence relationship between the subsets.

According to the embodiments of the present invention described above, key distribution of the broadcast encryption system extended to the public key encryption system can be realized.

### BRIEF DESCRIPTION OF THE DRAWINGS

FIG. 1 is an explanatory view showing a configuration of a key distribution system according to each embodiment of the present invention;

FIG. 2 is an explanatory view showing a hardware configuration of a key distribution server and a terminal device according to the embodiment;

FIG. 3 is an explanatory view showing a function configuration of the key distribution server according to a first embodiment of the present invention;

FIG. 4 is an explanatory view showing a structure of a binary tree according to the embodiment;

FIG. 5 is an explanatory view showing a directed graph H according to the embodiment;

FIG. 6 is an explanatory view showing a flow of a key distribution process according to the embodiment;

FIG. 7 is an explanatory view showing a flow of the key distribution process according to the embodiment;

FIG. 8 is an explanatory view showing a flow of the key distribution process according to the embodiment;

FIG. 9 is an explanatory view showing a flow of a graph generation method according to the embodiment;

FIG. 10 is an explanatory view showing the function configuration of the information processing device according to the embodiment;

FIG. 11 is an explanatory view showing a method of setting an identifier according to the embodiment;

FIG. 12 is an explanatory view showing the method of setting the identifier according to the embodiment;

FIG. 13 is an explanatory view showing the key setting process according to the embodiment;

FIG. 14 is an explanatory view showing the key distribution process according to the embodiment;

FIG. 15 is an explanatory view showing an application example of the key distribution system according to the embodiment;

FIG. 16 is an explanatory view showing an application example of the key distribution system according to the embodiment;

FIG. 17 is an explanatory view showing a configuration of a key distribution server according to a second embodiment of the present invention;

FIG. 18 is an explanatory view showing a directed graph I according to the embodiment;

FIG. 19 is an explanatory view showing the directed graph I according to the embodiment;

FIG. 20 is an explanatory view showing a flow of a graph generation method according to the embodiment;

FIG. 21 is an explanatory view showing the method of setting the identifier according to the embodiment;

FIG. 22 is an explanatory view showing the key setting method according to the embodiment;

FIG. 23 is an explanatory view showing the key distribution process according to the embodiment;

FIG. 24 is an explanatory view showing a configuration of a key distribution server according to a third embodiment of the present invention;

FIG. 25 is an explanatory view showing a flow of a graph generation method according to the embodiment;

FIG. 26 is an explanatory view showing a flow of a graph generation method according to the embodiment;

FIG. 27 is an explanatory view showing a flow of a graph generation method according to the embodiment;

FIG. 28 is an explanatory view showing a flow of a graph generation method according to the embodiment;

FIG. 29 is an explanatory view showing a flow of a graph generation method according to the embodiment;

FIG. 30 is an explanatory view showing the directed graph I according to the embodiment;

FIG. 31 is an explanatory view showing a method of setting the identifier according to the embodiment;

FIG. 32 is an explanatory view showing the key setting method according to the embodiment;

FIG. 33 is an explanatory view showing the key distribution process according to the embodiment;

FIG. 34 is an explanatory view showing a configuration of a key distribution server according to a fourth embodiment of the present invention;

FIG. 35 is an explanatory view showing a flow of a graph generation method according to the embodiment;

FIG. 36 is an explanatory view showing a flow of a graph generation method according to the embodiment;

FIG. 37 is an explanatory view showing a flow of a graph generation method according to the embodiment;

FIG. 38 is an explanatory view showing a flow of a graph generation method according to the embodiment;

FIG. 39 is an explanatory view showing a flow of a graph generation method according to the embodiment;

FIG. 40 is an explanatory view showing the directed graph I according to the embodiment;

FIG. 41 is an explanatory view showing a method of setting the identifier according to the embodiment;

FIG. 42 is an explanatory view showing the key setting method according to the embodiment; and

FIG. 43 is an explanatory view showing the key distribution process according to the embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### [Outline of Fundamental Technology]

Prior to describing the preferred embodiments of the present invention in detail, an AI system, an RS system, an RC system, and an RCS system capable of being applied with the technique according to the embodiments described in detail below will be briefly described. The application scope of the relevant technique is obviously not limited thereto, and can be applied to various broadcast encryption systems to be realized now or in the future.

### (Outline of AI System)

The AI system will be briefly described as one example of the broadcast encryption system. A key distribution system of the AI system is configured by a key distribution server and a plurality of terminal devices, and the like.

In the AI system, consider a set of the entire terminal device with each terminal device contained in the key distribution system corresponded to the element of the set. The key distribution is realized using a plurality of subsets obtained by dividing the set. First, the key distribution server forms a binary tree (BT) and corresponds each terminal device to a leaf node. The key distribution server then generates a set having such subset as the element according to a predetermined rule. Furthermore, the key distribution server corresponds each generated set to a root node and each intermediate node of the BT. The key distribution server corresponds the plurality of subsets contained in the set according to a predetermined algorithm. The detailed description will be omitted herein, but an arbitrary tree structure may be used in place of the binary tree.

In this case, the correspondence relationship between the subsets is expressed by correspondence information referred to as directional branch which provides directivity to the correspondence relationship. Furthermore, the set is expressed by a directed graph formed by connecting the directed branch. The directed graph is expressed as a coupling chain of the directional branch connecting each coordinate point on a horizontal coordinate axis. Each coordinate point on the horizontal coordinate axis is corresponded with each subset contained in one set corresponding to the relevant directed graph. The directional branch is expressed by a coupling line such as a curve or a refracting line connecting the coordinate points. The key distribution server can build the respective directed graph and set the relationship between the subsets, which are the elements of each set, with respect to each set corresponding to the root node contained in the BT and each intermediate node using the above expressions. This will be described using specific examples at a later stage.

After the graph generating process above is completed, the key distribution server generates the key to be distributed to each terminal device. First, the key distribution server selects the subset in which the terminal device of the distributing destination is contained as an element, and specifies the directed graph containing the relevant subset. The key distribution server repeatedly uses a pseudo-random sequence generator (PRSG) and generates the key to be distributed to the terminal device of the distributing destination based on the specified directed graph. In the embodiments to be hereinafter described, the technique for setting the key without using the PRSG will be described. The AI system is a broadcast encryption system in which the amount of communication, the number of keys to be held by the terminal device, and the amount of calculation for generating the key are relatively low.

However, since the key distribution system of the AI system is configured such that the key distribution server generates and distributes the key (common key), it is difficult to be used a key distribution system of a public key encryption system. In view of such situation, a technique of extending the key distribution system of the AI system to the public key encryption system is disclosed as one of the embodiments to be hereinafter described.

### (Outline of RS, RC, RCS Systems)

As another example of the broadcast encryption system, the RS system, the RC system, and the RCS system modified from the AI system will be briefly described. The key distribution system of the RS system, the RC system, and the RCS system is configured by a key distribution server and a plurality of terminal devices, and the like, similar to the key distribution system of the AI system.

The RS system is a modified system subjected to modification of reducing the number of keys to be held by each terminal device from the AI system by adding the process of reducing the length of the directional branch configuring the directed graph. The RC system is a modified system subjected to modification of reducing the amount of calculation for generating the key from the AI system by forming the directed graph so that the length of the directional branch becomes long. The RCS system is a modified system subjected to modification of reducing the number of keys to be held by each terminal device and reducing the amount of calculation for generating the key from the AI system by replacing a predetermined directional branch with the short directional branch, similar to the RS system, after forming a directed graph with long directional branch, similar to the RC system.

However, similar to the AI system, the key distribution system of the RS system, the RC system, and the RCS system is configured such that the key distribution server generates and distributes the key (common key), and thus it is difficult to be used a system of a public key encryption system. In view of such situation, a technique of extending the key distribution system of the RS system, the RC system, and the RCS system to the public key encryption system is disclosed as one of the embodiments to be hereinafter described. Such technique inherits the characteristics of the underlying broadcast encryption system, however, and thus satisfactory characteristics are obtained in terms of communication amount, number of keys to be held by the terminal device, amount of calculation for generating the key, and the like when the RS system, the RC system, and the RCS system are applied rather than having the AI system as the base.

The relevant technique is common in the fundamental portion of the technical concept, and the application range can be extended not only to the AI system, the RS system, the RC system, and the RCS system, but also to other broadcast encryption systems. That is, the technical scope according to the present invention is obviously not limited to extending the AI system, the RS system, the RC system, and the RCS system to the public key encryption system.

### (Outline of Solving Means)

The technique according to the embodiments described below provides a section for adding the element of hierarchical ID base encryption system (hereinafter HIBE system) to the broadcast encryption system such as the AI system, the RS system, the RC system, and the RCS system, and extending the AI system, the RS system, the RC system, and the RCS system to the public key encryption system. The technique related to the HIBE system is disclosed, for example, in “Hierarchical Identity Based Encryption with Constant Size Cipher text”, Proceedings of Eurocrypt 2005, volume 3494 of Lecture Notes in Computer Science, pages 440-456, Springer-Verlag, 2005.

The HIBE system is a technique extended from the ID base encryption system which enables hierarchization of the distributor (center) of the key. In the HIBE system, an identifier (ID) of the terminal device (user) is corresponded to each node of the tree structure, and the key corresponding to the identifier is generated by the terminal device corresponding to the parent node of the relevant terminal device. Therefore, generation of key by the user corresponding to the node other than the root of the tree structure becomes possible, different from the AI system and the like.

If the user other than the root generates and distributes the key as in the HIBE system, application can be made to the application using sharing of encrypted files. That is, a certain user creates a file to be encrypted, and allows browsing or editing only within a certain group.

Consider the following case by way of an example. “First, the user of the distributing source encrypts the file to be encrypted based on a predetermined broadcast encryption system, and broadcast transmits the same to the users in the group. The user in the group receiving the file decrypts the file and again encrypts the file after editing to broadcast the file to other users in the group”.

In such case, if the broadcast encryption system of the common key system such as the AI system is applied, the reliability of the user who edits and retransmits the file is preferably sufficiently high in order to ensure sufficient security. However, it is realistically difficult in most cases to guarantee the reliability of the user who becomes the distributing destination of the file. A technique for extending the broadcast encryption system to the public key encryption system is thus desired. The key distribution server according to this technique sets the public key and the private key, and distributes the private key to each terminal device (user) and publicizes the public key. Therefore, each user can encrypt the file using the public key and freely transmit the file. This technique will be specifically described below.

### First Embodiment

A system configuration and a specific section related to key distribution of the key distribution system according to a first embodiment of the present invention will now be described in detail. The present embodiment relates to a key distribution technique by the broadcast encryption system in which the AI system is extended to the public key encryption system. A key distribution system 100 according to the AI system will be described below.

### [Configuration of Key Distribution System 100 According to AI System]

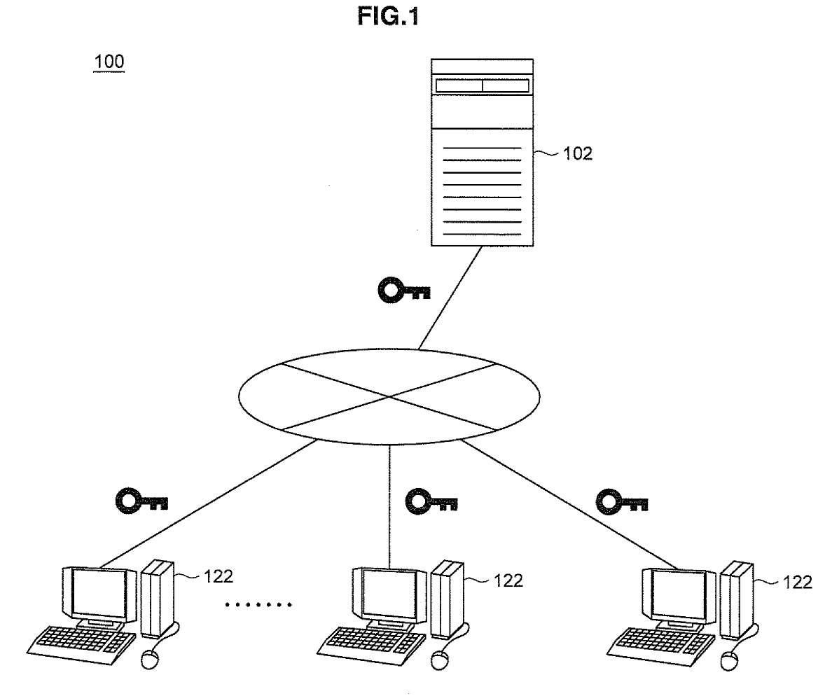

First, a system configuration of the key distribution system 100 according to the AI system will be described with reference to FIG. 1. FIG. 1 is an explanatory view showing a system configuration of the key distribution system 100 according to the AI system.

With reference to FIG. 1, the key distribution system 100 is mainly configured by a key distribution server 102, terminal devices 122, and a network 10. The key distribution server 102 is an example of an information processing device.

### (Network 10)

First, the network 10 will be described. The network 10 is a communication line network for connecting the key distribution server 102 and the terminal device 122 in bidirectional communication or one-way communication. The network 10 is configured by a public line network such as Internet, telephone line network, satellite communication network, and broadcast communication path, and dedicated line network such as WAN (Wide Area Network), LAN (Local Area Network), IP-VPN (Internet Protocol-Virtual Private Network), and wireless LAN, and may be wired or wireless.

### (Key Distribution Server 102)

The key distribution server 102 will be briefly described. The key distribution server 102 is a section for encrypting and distributing various electronic data. For instance, the key distribution server 102 can encrypt and distribute a content. Here, the key distribution server 102 uses a content key for encrypting or decrypting the content. The key distribution server 102 can also encrypt and distribute the content key with respect to a predetermined terminal device 122. The key distribution server 102 encrypts the content key using a key generated according to a predetermined algorithm so that only the predetermined terminal device 122 can decrypt the content key. Thus, the terminal device 122 which is not permitted to reproduce the content may not decrypt the content key even if the content key is acquired. The content key may respond to both encryption/decryption, or may be dedicated to decryption.

To realize such technique, the key distribution server 102 generates a set key used in encryption or decryption of the content key. Here, the key distribution server 102 divides the terminal devices 122 contained in the key distribution system 100 to a plurality of groups, and generates the set key for every group. The key distribution server 102 expresses each group with a subset of a certain set, and generates the set key based on the relationship between the subsets (directional branch and directed graph). The key distribution server 102 may acquire the directed graph from another device or may generate the directed graph based on a predetermined algorithm.

The key distribution server 102 encrypts the content key with a predetermined set key. In this case, the key distribution server 102 selects one or more subsets including the terminal device 122 of the user permitted to reproduce the content as the element, and encrypts the content key using the set key corresponding to the relevant subset. The key distribution server 102 then distributes the encrypted content, the encrypted content key, and the information of the selected subset to the terminal device 122 contained in the key distribution system 100. The terminal device 122 is given one or more keys (set key or intermediate key) for generating the set key corresponding to each subset for all the subsets to which it belongs. The key distribution server 102 may notify information related to one part of or all of the diagraph for generating the set key to each terminal device 122 in advance.

The key distribution server 102 uses the pseudo-random sequence generator (PRSG) when generating the set key. The PRSG is a device or a program capable of outputting a pseudo-random number sequence of a long period by inputting a predetermined seed value. The pseudo-random sequence generator logic is realized using linear congruential method and Mersenne Twister method. It should be noted that the pseudo-random numbers may be generated using other logics or that a predetermined special pseudo-random number sequence may be used. The key distribution server 102 can be configured by an information processing device such as personal computer (PC) having a server function. The key distribution server 102 can transmit various information to the external device via the network 10. The key distribution server 102 can also distribute the content and the content key to a plurality of terminal device 122 via the network 10.

The key distribution server 102 may have a function of providing the content distribution service such as video distribution service or electronic music distribution service. For instance, the key distribution server 102 can distribute video content of moving image or still image such as movie, television program, video program, and figures, audio content of music, lecture, and radio program, game content, document content, or content of software and the like. The key distribution server 102 may distribute the encrypted content key instead of the encrypted content. When the encrypted content is distributed by the external device, the key distribution server 102 can encrypt and distribute the content key to divide the management of the content and the management of the permitted contractor.

The key distribution server 102 can permit the reproduction of the content only to the predetermined terminal device 122 by applying the above technique. Furthermore, the key distribution server 102 can easily change the combination of the permitted terminal device 122 by changing the combination of the set key.

### (Terminal Device 122)

The functions of the terminal device 122 will be briefly described below. The terminal device 122 acquires various information from the key distribution server 102 via the network 10. For instance, the terminal device 122 acquires the encrypted content and the content key. The terminal device 122 acquires the information of the subset provided from the key distribution server 102. The terminal device 122 may hold the key for generating the set key of the subset to which it belongs and the information of the directed graph for generating the set key. The terminal device 122 may hold the algorithm for generating the directed graph. The terminal device 122 generates the desired set key from the held key based on the information of the held directed graph or the information of the generated directed graph. Here, the terminal device 122 generates the set key using the pseudo-random sequence generator (PRSG). The terminal device 122 decrypts the content key using the generated set key and decrypts the content using the decrypted content key.

The terminal device 122 is an information processing terminal capable of communicating with the external device by way of the network 10, and may be information household electronics such as PC, PDA (Personal Digital Assistant), household game machine, DVD/HDD recorder, or television receiver, television broadcast tuner or decoder, or portable game machine, portable telephone, portable video/audio player, PDA, PHS, or the like.

### [Hardware Configuration of Key Distribution Server 102 and Terminal Device 122]

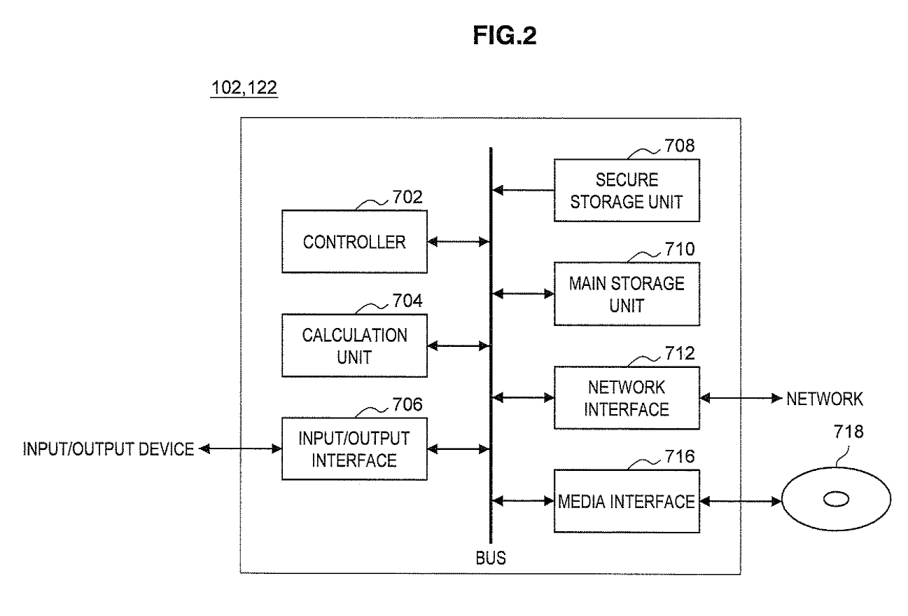

A hardware configuration example of the key distribution server 102 and the terminal device 122 will be described with reference to FIG. 2. FIG. 2 is an explanatory view showing a hardware configuration example capable of realizing the functions of the key distribution server 102 or the terminal device 122.

As shown in FIG. 2, the key distribution server 102 or the terminal device 122 is mainly configured by a controller 702, a calculation unit 704, an input/output interface 706, a secure storage unit 708, a main storage unit 710, a network interface 712, and a media interface 716.

### (Controller 702)

The controller 702 is connected to other components by way of a bus and realizes the function of controlling each unit based on the program and the data stored in the main storage unit 710. The controller 702 may be configured by calculation processing devices such as central processing unit (CPU).

### (Calculation Unit 704)

The calculation unit 704 of the key distribution server 102 can realize encryption/decryption of contents, encryption/decryption of content keys, generation of directed graph, generation of set key, and generation of intermediate key used to generate the set key. The calculation unit 704 can realize the function of the pseudo-random sequence generator (PRSG).

The calculation unit 704 is configured by calculation processing devices such as central processing unit (CPU), and can realize each function above based on the program and the data stored in the main storage unit 710. For instance, the calculation unit 704 can generate the directed graph based on the program recorded in the main storage unit 710. Therefore, the predetermined algorithm for generating the directed graph is expressed by the program recorded in the main storage unit 710, the secure storage unit 708, or the like. The calculation unit 704 can record the output result to the main storage unit 710 or the secure storage unit 708. The calculation unit 704 may be integrally formed with the controller 702.

### (Input/Output Interface 706)

The input/output interface 706 is mainly connected to an input device for the user to input data, and an output device for outputting the content of the calculation result or the content. The input device may be keyboard, mouse, track ball, touch pen, keypad, touch panel, or the like. The input device may be wired or wirelessly connected to the input/output interface 706. The input device may be a wired or wirelessly connected portable information terminal such as portable telephone and PDA. The output device may be a display device such as display, an audio output device such as speaker, or the like. The output device may be wired or wirelessly connected to the input/output interface 706.

The input/output interface 706 is connected to other components by way of a bus, and can transmit data input through the input/output interface 706 to the main storage unit 710, and the like. The input/output interface 706 outputs the data stored in the main storage unit 710 and the like, the data input through the network interface 712 and the like, the calculation result output from the calculation unit 704, or the like to the output device.

(Secure storage unit 708)

The secure storage unit 708 is a storage device for safely storing mainly data requiring confidentiality such as content key, set key, and intermediate key. The secure storage unit 708 may be configured with a magnetic storage device such as hard disc, an optical storage device such as optical disc, an magnetic-optical storage device, a semiconductor storage device, or the like. The secure storage unit 708 may have tamper resistance property.

### (Main Storage Unit 710)

The main storage unit 710 stores an encryption program for encrypting the content or the content key, a decryption program for decrypting the encrypted content or the content key, a key generation program for generating the set key or the intermediate key. The main storage unit 710 may temporarily or permanently store the calculation result output from the calculation unit 704, or record data input from the input/output interface 706, the network interface 712, or the media interface 716. The main storage unit 710 may be configured by a magnetic storage device such as hard disc, an optical storage device such as optical disc, an magnetic-optical storage device, a semiconductor storage device, or the like.

### (Network Interface 712)

The network interface 712 is a communication unit connected to other communication devices by way of the network 10 for transmitting and receiving encrypted content or content key, parameter used in encryption such as set key and intermediate key, and data related to the subset of the terminal device 122 permitted to reproduce the content. The network interface 712 is connected to other components by way of the bus, and transmits data received from the external device on the network 10 to other components or transmits data of other components to the external device on the network 10.

### (Media Interface 716)

The media interface 716 is an interface for removably attaching an information media 718 to read or write data, and is connected to other components by way of the bus. The media interface 716 has a function of reading the data from the attached information media 718 and transmitting the same to other components, or writing the data provided from other components in the information media 718. The information media 718 may be a removable storage medium such as optical disc, magnetic disc, and semiconductor memory, or may be a storage medium of an information terminal wired or wirelessly connected at a relatively close distance without the network 10.

One example of the hardware configuration capable of realizing the functions of the key distribution server 102 and the terminal device 122 has been described above. Each component above may be configured using a universal member or may be configured by a dedicated hardware specialized for the function of each component. Some components such as the media interface 716 or the input/output interface 706 may be omitted according to the usage mode.

### [Function Configuration of Key Distribution Server 102]

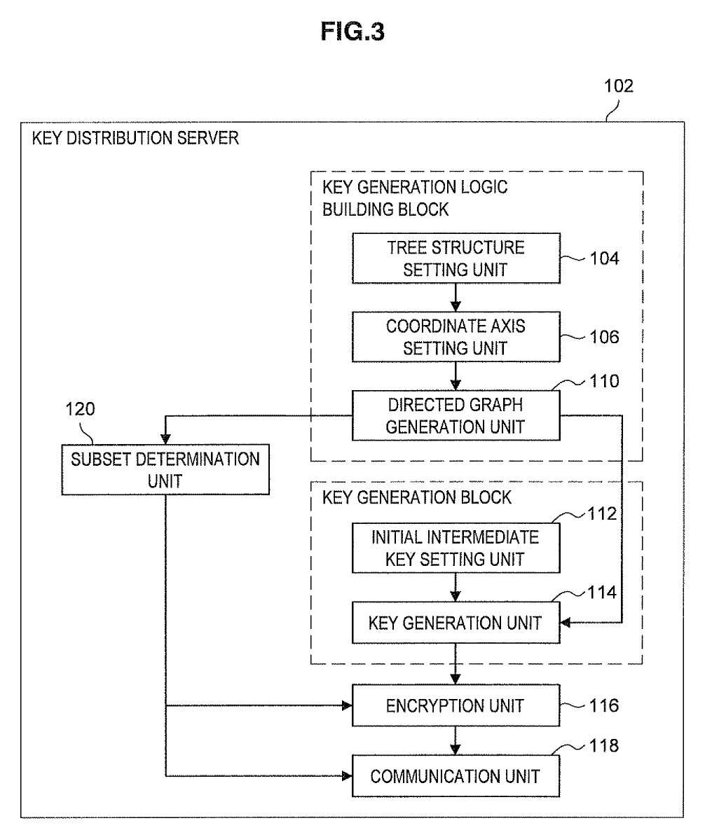

The function configuration of the key distribution server 102 will now be described with reference to FIG. 3. FIG. 3 is an explanatory view showing a function configuration of the key distribution server 102.

As shown in FIG. 3, the key distribution server 102 is mainly configured with a tree structure setting unit 104, a coordinate axis setting unit 106, a directed graph generation unit 110, an initial intermediate key setting unit 112, a key generation unit 114, an encryption unit 116, a communication unit 118, and a subset determination unit 120.

The tree structure setting unit 104, the coordinate axis setting unit 106, and the directed graph generation unit 110 are collectively referred to as “key generation logic building block”. The initial intermediate key setting unit 112 and the key generation unit 114 are collectively referred to as “key generation block”. For the sake of convenience of explanation, expressions such as tree structure, coordinate axis, directional branch, directed graph, set, and subset are used, but the main part of the technical idea of the present embodiment does not depend on such expression mode. Therefore, variants fall within the technical scope of the present embodiment even if the expression modes are different.

### (Tree Structure Setting Unit 104)

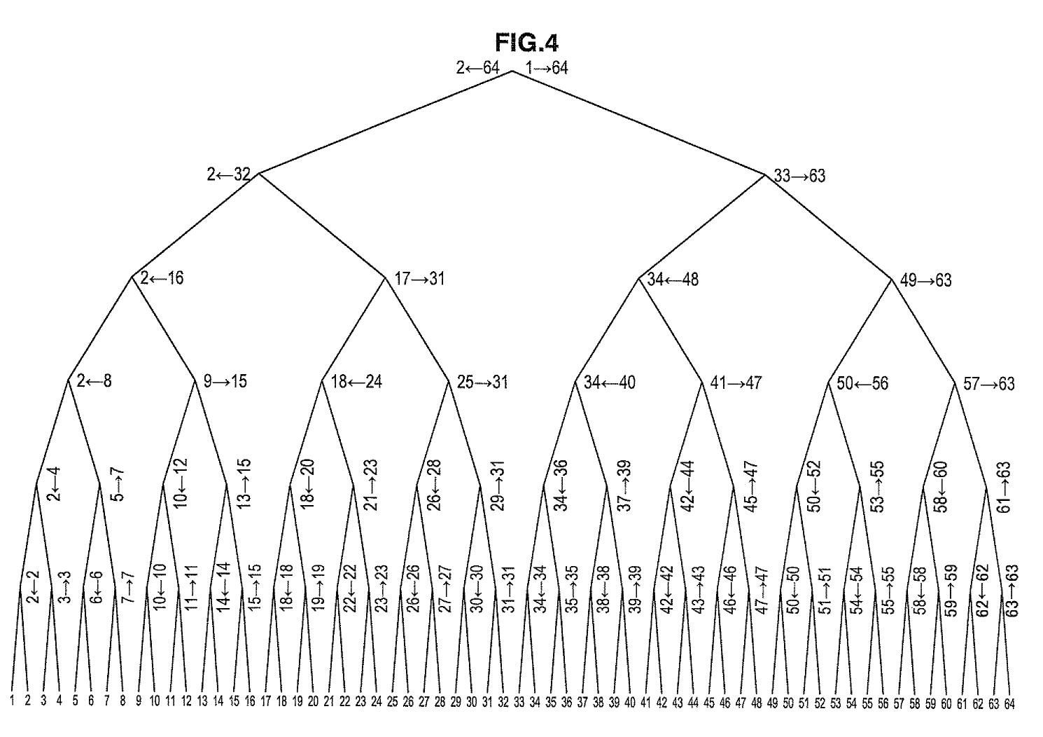

First, the function configuration of the tree structure setting unit 104 will be described. The tree structure setting unit 104 has a function of generating the binary tree BT as shown in FIG. 4. The binary tree BT is formed by the tree structure setting unit 104 through the following building method. In the following description, the terminal device 122 of the contractor u is sometimes simply referred to as contractor u. The mathematical expression is defined as below.

### DEFINITION

(1) The set N representing all the contractors (1, . . . , n) is defined as N={1, . . . , n}
(where n is power of two)
(2) The following expression is defined for natural numbers i and j

$$[ i , j ] = \{ i , i + 1 , … , j \} ( where , i < j ) \\ [ j , i ] = \{ i , i - 1 , … , j \} ( where , i < j )$$

$$( i \to i ) = ( i ← i ) = \{ \{ i \} \}$$

$$\begin{matrix}( i \to j ) = \{ \{ i \} , \{ i , i + 1 \} , … , \{ i , i + 1 , … , j \} \} \\ = \{ [ i , i ] , [ i , i + 1 ] , … , [ i , j ] \} ( where , i < j )\end{matrix}$$

$$\begin{matrix}( i ← j ) = \{ \{ j \} , \{ j , j - 1 \} , … , \{ j , j - 1 , … , i \} \} \\ = \{ [ j , j ] , [ j , j - 1 ] , … , [ j , i ] \} ( where , i < j )\end{matrix}$$

The node positioned at the end of the binary tree BT is referred to as leaf node, the node positioned at the apex is referred to as root node (root), and each node positioned between the root node and the leaf node is referred to as intermediate node. Each leaf node is corresponded to each contractor 1, . . . , n. The example of FIG. 4 is a case where the number of leaf nodes n of the BT is n=64.

### (Formation of Binary Tree)

The method of forming the binary tree BT in which the number of leaf nodes is n (e.g., n=64) will be considered.

First, the tree structure setting unit 104 corresponds numbers 1, . . . , n from the left end towards the right with respect to each leaf node. The tree structure setting unit 104 then corresponds the leaf nodes of numbers 1, . . . , n to the contractors 1, . . . , n. The tree structure setting unit 104 defines indices Iᵥ and rᵥ for determining the subset to be corresponded to the intermediate node v. Here, v is the number given in a predetermined order with respect to each intermediate node contained in the binary tree BT, and is an index representing the position of the intermediate node. The tree structure setting unit 104 sets the number of the left most leaf node as Iᵥ and the number of the right most leaf node as rᵥ of the leaf nodes positioned at the end of the branch extending from the intermediate node v.

The tree structure setting unit 104 classifies each intermediate node configuring the binary tree BT into two sets (BT_{L}, BT_{R}). The tree structure setting unit 104 defines the set of the intermediate node positioned on the left side of a parent node as BT_{L} and the set of the intermediate node positioned on the right side of the parent node as BT_{R} of the intermediate nodes existing on the binary tree BT. The parent node refers to the node positioned on the upper level of the two nodes connected by the branch.

The tree structure setting unit 104 corresponds the set (1→n) and the set (2←n) to the root node of the binary tree BT. The set representing part of or all of the leaf nodes existing at the lower level of the root node is set by combining a plurality of subsets contained in the set (1→n) and the set (2←n). All the leaf nodes excluding the leaf node u (1≦u≦n) is expressed by the sum of sets of the subset {1, . . . , u−1} contained in the set (1→n) and the subset {n, . . . , u+1} contained in the set (2←n).

In the case of FIG. 4, the set (1→64) and the set (2←64) are corresponded to the root node of the binary tree BT (n=64). The set (1→64) includes the subset [1, 1], . . . , [1, 64] as elements. For instance, the group of leaf nodes containing all the leaf nodes 1, . . . , 64 is expressed by the subset [1,64]={1, . . . , 64}. The group of all the leaf nodes excluding the leaf node 16 and the leaf node 17 is expressed by the subset [1, 15] and the subset [64, 18]. However, the subset [1, 15] is included in the set (1→64), and the subset [64, 18] is included in the set (2←64).

The tree structure setting unit 104 corresponds the subset to each intermediate node configuring the binary tree BT. The tree structure setting unit 104 corresponds the set (lᵥ+1←rᵥ) to the intermediate node v belonging to the set BT_{L}. The tree structure setting unit 104 corresponds the set (lᵥ→rᵥ−1) to the intermediate node v belonging to the set BT_{R}.

In the case of FIG. 4, the set (2←4) is corresponded to the intermediate node n corresponding to 1ᵥ=1, rᵥ=4. The leaf nodes 1, . . . , 4 are positioned at the end of the intermediate node v since 1ᵥ=1, rᵥ=4. For instance, the combination of the leaf nodes 1, 2, and 4 is expressed by the combination of the subset [1, 2]={1, 2} contained in the set (1→64) of the root node positioned at the upper level of the intermediate node v and the subset [4, 4]={4} contained in the subset (2←4) of the intermediate node v.

As can be presumed from the specific example above, the leaf nodes can be freely grouped and expressed by combining the subsets of the sets corresponded to the root node and each intermediate node of the binary tree BT. That is, the group containing only a predetermined contractor of the plurality of contractors can be expressed by the combination of subsets. The sum of sets representing the entire sets corresponded to each node of the binary tree BT is referred to as a set system SS and is defined as in equation (1).

$$SS = \{ {⋃}_{v ∈ {BT}_{L}} ( {l}_{v} + 1 ← {r}_{v} ) \} ⋃ \{ {⋃}_{v ∈ {BT}_{R}} ( {l}_{v} \to {r}_{v} - 1 ) \} ⋃ ( 1 \to n ) ⋃ ( 2 ← n ) \qquad eq . ( 1 )$$

The function configuration of the tree structure setting unit 104 according to the present embodiment has been described above. As described above, the tree structure setting unit 104 corresponds a predetermined subset to each node of the binary tree BT, and expresses the group of the contractor with the combination of the subsets. The section for generating the directed graph defining the correspondence relationship between the subsets will now be described.

### (Coordinate Axis Setting Unit 106)

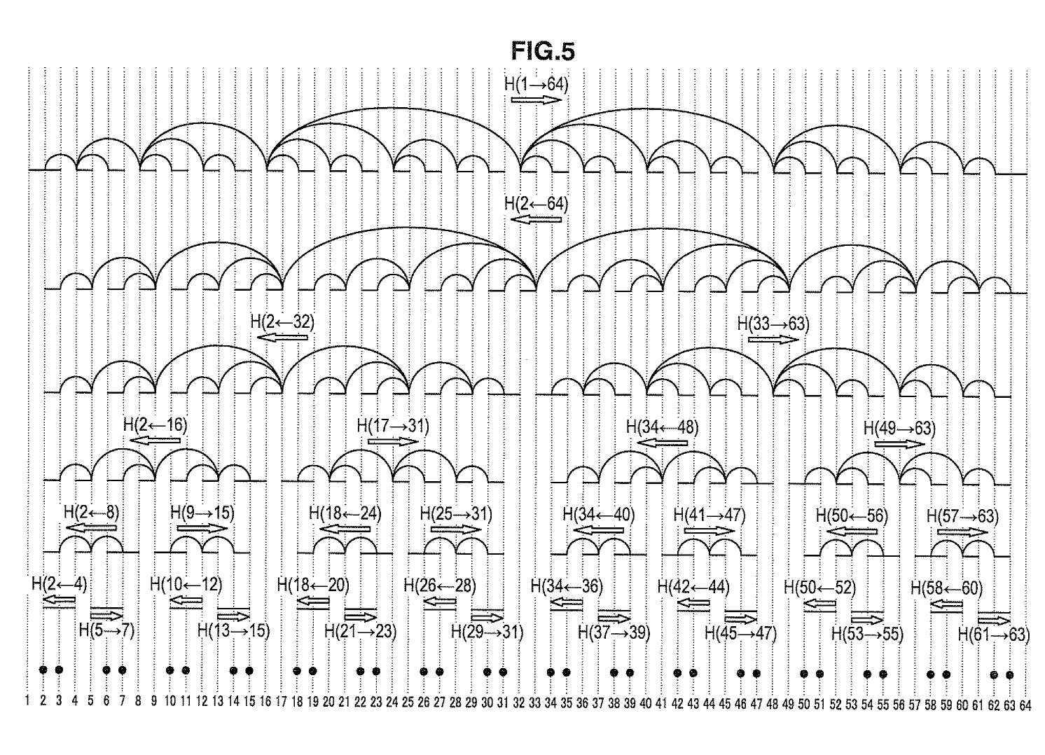

The functions of the coordinate axis setting unit 106 will be described with reference to FIG. 5. The coordinate axis setting unit 106 is a section for setting a plurality of horizontal coordinate axes for forming the directed graph. FIG. 5 is an explanatory view showing a directed graph H corresponding to the binary tree BT of FIG. 4.

The coordinate axis setting unit 106 corresponds the plurality of subsets contained in the set (1→n−1) to each coordinate point on one horizontal coordinate axis so that the inclusion relation becomes larger towards the right, and forms the horizontal coordinate axis of the set (1→n−1). The coordinate axis setting unit 106 also corresponds the plurality of subsets contained in the set (lᵥ→rᵥ−1) corresponded to the intermediate node v to the coordinate point on one horizontal coordinate axis so that the inclusion relation becomes larger towards the right for the intermediate node v or v εBT_{R} of the binary tree BT, and forms the horizontal coordinate axis corresponding to the set (lᵥ→rᵥ−1). Similarly, the coordinate axis setting unit 106 forms the horizontal coordinate axis corresponding to the set (lᵥ→rᵥ−1) for all the v or v εBT_{R}.

The coordinate axis setting unit 106 then corresponds the plurality of subsets contained in the set (2←n) to each coordinate point on one horizontal coordinate axis so that the inclusion relation becomes larger towards the left, and forms the horizontal coordinate axis of the set (2←n). The coordinate axis setting unit 106 also corresponds the plurality of subsets contained in the set (lᵥ+1←rᵥ) to the coordinate point on one horizontal coordinate axis so that the inclusion relation becomes larger towards the left, and forms the horizontal coordinate axis of the set (lᵥ+1←rᵥ). Similarly, the coordinate axis setting unit 106 forms the horizontal coordinate axis of the set (lᵥ+1←rᵥ) for all the v or v εBT_{R}.

The subsets [5,5], [5,6], [5,7] are corresponded in order from the left with respect to each coordinate point of the horizontal axis of the sets (5→7)={[5,5], [5,6], [5,7]}.

The coordinate axis setting unit 106 then arranges one temporary coordinate point each on the right side of the coordinate point positioned at the right end of the horizontal coordinate axis of the set (1→n−1) and on the left side of the coordinate point positioned at the left end of the horizontal coordinate axis. The coordinate axis setting unit 106 arranges one temporary coordinate point each on the right side of the coordinate point positioned at the right end of the horizontal coordinate axis of the set (lᵥ→rᵥ−1) and on the left side of the coordinate point positioned at the left end of the horizontal coordinate axis of the set (lᵥ→rᵥ−1). The coordinate axis setting unit 106 also arranges one temporary coordinate point each on the right side of the coordinate point positioned at the right end of the horizontal coordinate axis of the set (2←n) and on the left side of the coordinate point positioned at the left end of the horizontal coordinate axis of the set (2←n). The coordinate axis setting unit 106 arranges one temporary coordinate point each on the right side of the coordinate point positioned at the right end of the horizontal coordinate axis of the set (lᵥ+1←rᵥ) and on the left side of the coordinate point positioned at the left end of the horizontal coordinate axis of the set (lᵥ+1←rᵥ).

The coordinate axis setting unit 106 generates a plurality of horizontal coordinate axes used to form the directed graph of the AI system according to the above algorithm. The method of forming the directed graph on the horizontal coordinate axis will now be described.

### (Directed Graph Generation Unit 110)

The function configuration of the directed graph generation unit 110 will now be described. The directed graph generation unit 110 is a section for forming the directed graph H on each horizontal coordinate axis.

First, the directed graph generation unit 110 sets a parameter k (k is an integer). The directed graph generation unit 110 then determines an integer x satisfying the condition n^{(x-1)/k}<rᵥ−lᵥ+1≦n^{x/k}. Assume k|log(n) (hereinafter the base of log is 2). The parameter k is a parameter determined according to the configuration of the key distribution system 100 since it relates to the number of intermediate keys to be held by the terminal device 122 and the amount of calculation for generating the set key.

The directed graph generation unit 110 forms a rightward directional branch having a length n^{i/k}(i=0 to x−1) on the horizontal coordinate axis of set (1→n−1) and on the horizontal coordinate axis of the set (lᵥ→rᵥ−1). For instance, the counter i is changed from 0 to x−1, and the rightward directional branch of length n^{i/k} is continuously formed from the temporary coordinate point arranged on the left of the left most coordinate point, and completed when the directional branch reaches the temporary coordinate point arranged on the right of the right most coordinate point or when the directional branch exceeds the temporary coordinate point. The coordinate point at the most left corresponds to the subset of minimum element number.

The directed graph generation unit 110 forms a leftward directional branch having a length n^{i/k}(i=0 to x−1) on the horizontal coordinate axis of set (2←n) and on the horizontal coordinate axis of set (lᵥ+1←rᵥ). Similarly, the directed graph generation unit 110 forms the directional branch on the horizontal coordinate axis corresponding to all the v. This is realized through a method in which the left and the right are reversed from the above method.

The directed graph generation unit 110 then erases all the directional branches having a temporary coordinate point as the starting end or the terminating end arranged on each horizontal coordinate axis. The directed graph generation unit 110 leaves only the longest directional branch from a plurality of directional branches if a plurality of directional branches reaches one coordinate point, and erases all other directional branches. Through the above process, the directed graph (1→n−1) of set (1→n−1), the directed graph H(2←n) of set (2←n), the directed graph H(lᵥ→rᵥ−1) of the set (lᵥ→rᵥ−1), and the directed graph H(lᵥ+1←rᵥ) of the set (lᵥ+1←rᵥ) are generated.

The directed graph generation unit 110 then adds the rightward directional branch having length of one having the temporary coordinate point arranged on the right side of the horizontal coordinate axis of the set (1→n−1) as the terminating end to the directed graph H(1→n−1). That is, the directed graph generation unit 110 executes the process of the following equation (2) and generates the directed graph H(1→n) of the set (1→n). E(H( . . . )) represents the set of the directional branch contained in the graph H( . . . ).

E(H(1→n))=E(H(1→n−1))∪{([1,n−1],[1,n])} eq. (2)

The functions of the directed graph generation unit 110 have been described above. The directed graph H of the AI system is formed as described above.

### Specific Example of Directed Graph

A brief description on the configuration of the directed graph will be added with reference to FIG. 5.

Using the directed graph H(33→63) by way of example, the directed graph H(33→63) is configured by a plurality of arch-shaped curves, and a line being connected to one end of each arch-shaped curve and extending horizontally. The arch-shaped curve and the horizontally extending line are directional branches. The line represents the directional branch having length of one, and the curve represents the directional branch having length of two or more, but the difference on whether a line or a curve is an issue of notation, and is irrelevant from the technical main part of the present embodiment. The outlined arrow displayed on the upper side at the middle of the directed graph H(33→63) indicates the direction of the directional branch. The black circle draw at the lowermost stage represents the directed graph H(2←2), . . . , H(63→63) in order from the left.

In FIG. 5, in addition to the directed graph H(33→63), a plurality of directed graphs H corresponding to the root node and the intermediate node of the binary tree BT, and a plurality of vertical lines z(z=1 to 64) intersecting each directed graph H are drawn. The intersection between the vertical line z and the directed graph H represents a coordinate point on the horizontal coordinate axis. The intersection of the directed graph H(lᵥ+1←rᵥ) and the vertical line z represents a coordinate point corresponding to the subset [rᵥ, z], and the intersection of the directed graph H(lᵥ→rᵥ−1) and the vertical line z represents a coordinate point corresponding to the subset [lᵥ, z]. For instance, the intersection of the directed graph H(1→64) and the vertical line 10 represents a coordinate point of the subset [1,10]. Such expression will be used below.

### (Key Generation Unit 114)

The functions of the key generation unit 114 will now be described. The key generation unit 114 is a section for generating the intermediate key or the set key based on the directed graph H. In the following description, the coordinate point associated with the subset S is sometimes simply noted as coordinate point S. The mathematical expression below is sometimes used.

### DEFINITION

Intermediate key corresponding to subset Sᵢ: t(Sᵢ)

Set key corresponding to subset Sᵢ: k(Sᵢ)

Content key: mek

Pseudo-random sequence generator: PRSG

Set of directional branch: E

Directional path: P

The key generation unit 114 uses the pseudo-random sequence generation PRSG to generate the set key. The key generation unit 114 inputs the intermediate key t(S₀) of the subset S₀ to the pseudo-random sequence generator PRSG, and acquires the set key k(S₀) of the subset S₀ and the intermediate keys t(S₁), t(S₂), . . . , t(S_{q}) corresponding to each of the plurality of subsets S₁, S₂, . . . , S_{d}. The relation between the (input) subset S₀ and the (output) other subsets S₁, . . . , S_{q} is defined by the directed graph H. The set S₀, S₁, . . . , S_{q} is one of the subsets configuring the set system SS. Furthermore, q is the number of directional branch having the coordinate point of the subset S₀ as the starting point in the directed graph H.

The process in which the intermediate key t(S₀) is input to the pseudo-random sequence generator PRSG, and the set key k(S₀) and the plurality of intermediate keys t(S₁), . . . , t(S_{q}) are output is expressed as in the following equation (3). If k directional branches having the coordinate point S₀ as the starting point exist and the coordinate points indicating the terminating ends thereof are S₁, S₂, . . . , S_{q} when the directed graph H is referenced, the coordinate points are noted as S₁, S₂, . . . , S_{q} in order closest from the coordinate point S₀.

t(S₁)∥ . . . ∥t(S_{q})∥k(S₀)←PRSG(t(S₀)) eq. (3)

When the intermediate key t(S₀) corresponding to the coordinate point S₀ on the horizontal coordinate axis is input, the pseudo-random sequence generator PRSG outputs the intermediate keys t(S₁), t(S₂), t(S₃), . . . , t(S_{q}) and the set key k(S₀) corresponding to the coordinate point S₀ according to the subsets S₁, S₂, S₃, . . . , S_{q} corresponded to the terminating end of the directional branch having the coordinate point S₀ as the starting end based on the directed graph H of the AI system. Since the integer x determined by the directed graph generation unit 110 is 1≦x≦k, the number of directional branches having each coordinate point of the directed graph H as the starting point is a maximum of k.

If set such that the pseudo-random sequence generator PRSG obtains data output t(S₁)∥ . . . ∥t(S_{q})∥k(S₀)←PRSG(t(S₀)) of (q+1)*λ bits with respect to the data input t(S₀) of X bits, the key generation unit 114 can acquire the intermediate keys t(S₁), t(S₂), . . . , t(S_{q}) and the set key k(S₀) by extracting the output of the PRSG sectionalized by X bits from the left.

For instance, with reference to the directed graph H(1→64), four directional branches are output from the coordinate point S₀=[1, 8] (eighth coordinate point from the left end). The terminating ends of the four directional branches are coordinate points S₁=[1, 9], S₂=[1, 10], S₃=[1, 12], S₄=[1, 16]. Therefore, when the intermediate key t(S₀) is input to the pseudo-random sequence generator PRSG, the intermediate keys t(S₁), t(S₂), t(S₃), t(S₄) and the set key k(S₀) are generated. Furthermore, when the obtained intermediate key t(S₄) is input to the PRSG, the intermediate keys t(S₁₁), t(S₁₂), t(S₁₃), t(S₁₄), t(S₁₅) and the set key k(S₄) corresponding to the terminating end coordinate points S₁₁=[1, 17], S₁₂=[1, 18], S₁₃=[1, 20], S₁₄=[1, 24], S₁₅=[1, 32] of the directional branches having the coordinate point S₄ as the starting point are generated.

The key generation unit 114 can derive the set key corresponding to a plurality of coordinate points connected by the plurality of directional branches by repeatedly executing the pseudo-random sequence generation calculation based on the directed graph H. A path between two coordinate points configured by a plurality of directional branches is hereinafter referred to as directional path P.

When significant attention does not need to be paid to safety or when reducing the amount of calculation to generate the key set, a pseudo-random sequence generator PRSG capable of calculating a different set key k(S₁), . . . , k(S_{q}) from the set key k(S₀) based on the directed graph H may be adopted. In this case, when the set key k(S₀) is input to the pseudo-random sequence generator PRSG, the set keys k(S₁), k(S₂), k(S₃), . . . , k(S_{q}) corresponding to the arriving destination of the directional branch extending from the coordinate point S₀ are output.

### (Initial Intermediate Key Setting Unit 112)

The functions of the initial intermediate key setting unit 112 will be described below. The initial intermediate key setting unit 112 is a section for setting the intermediate key to be held to generate the desired set key by the key distribution server 102.

As described above, the key generation unit 114 can generate the set key corresponding to all the coordinate points to which the directional path having the coordinate point S corresponding to the intermediate key t(S) to input as the starting point can reach by iteratively executing the pseudo-random sequence generator PRSG. To this end, the key distribution server 102 holds at least the intermediate key of the coordinate point (hereinafter referred to as route) corresponding to the starting point of the directed graph H of each set when generating the set key of the subset contained in all the sets corresponded to the root node and the intermediate node configuring the binary tree BT by the key generation unit 114.

The initial intermediate key setting unit 112 generates the intermediate key corresponding to the route of each directed graph H. For instance, the initial intermediate key setting unit 112 generates a random number of λ bits when setting up the key distribution system 100, and sets the same as the intermediate key corresponding to the route of each directed graph H. The route of the directed graph H is defined as a coordinate point from which the directional branch is output but to which the directional branch does not reach. In the case of the directed graph H(1→64), the coordinate point [1, 1] is the route of the directed graph H(1→64). For the graph in which the coordinate point is only one such as directed graph H 3→3), the directional branch is not output therefrom, but the relevant coordinate point is considered as the route.

### (Subset Determination Unit 120)

The subset determination unit 120 is a section for determining the set key to use to encrypt the content key. The subset determination unit 120 extracts at least one subset including the contractor (hereinafter referred to as permitted contractor) permitted to reproduce the content, and determines the type of set key (i.e., corresponding subset) to be distributed to each contractor. For instance, the subset determination unit 120 determines the set (R) of the contractor (hereinafter referred to as eliminated contractor) not permitted to reproduce the content, and the set (N\R) of only permitted contractors excluding the set (R) of the eliminated contractor from the set (N) of all the contractors. The subset determination unit 120 then determines a set (S₁, S₂, . . . , Sₘ) of subsets in which the set (N\R) of permitted contractors can be formed by the sum of sets (N\R=S₁∪S₂∪ . . . ∪Sₘ) using the subset contained in the set system SS. In this case, the number m of subset is preferably small.

### (Encryption Unit 116)

The function of the encryption unit 116 will now be described. The encryption unit 116 encrypts the content key using the set key, and generates an cipher text. The encryption unit 116 encrypts the content key using a plurality of set keys corresponding to a predetermined subset of all the subsets configuring the set system SS. In this case, the encryption unit 116 may encrypt the content key using all the set keys generated by the key generation unit 114, but may encrypt the content key using the set key k(S₁), k(S₂), . . . , k(Sₘ) corresponding to a set of subsets (S₁, S₂, . . . , Sₘ) determined by the subset determination unit 120. The encryption unit 116 encrypts the content using the content key.

### (Communication Unit 118)

The function configuration of the communication unit 118 will now be described. The communication unit 118 distributes a predetermined intermediate key to each contractor based on the directed graph H mainly in time of system setup. The communication unit 118 distributes all the intermediate keys for each contractor to derive all the set keys of the subset to which the contractor is included. In time of system operation, the communication unit 118 distributes the content or the content key encrypted by the encryption unit 116 to all the contractors. The communication unit 118 distributes the information for generating partial or entire directed graph to each contractor. The communication unit 118 also distributes the information (e.g., information of subset (S₁, S₂, . . . , Sₘ)) related to the set (N\R) of permitted contractors or the set (N\R=S₁∪S₂∪ . . . ∪Sₘ) of permitted contractors to each contractor.

The function configuration of the key distribution server 102 of the AI system has been described above.

### [Key Distribution Method]

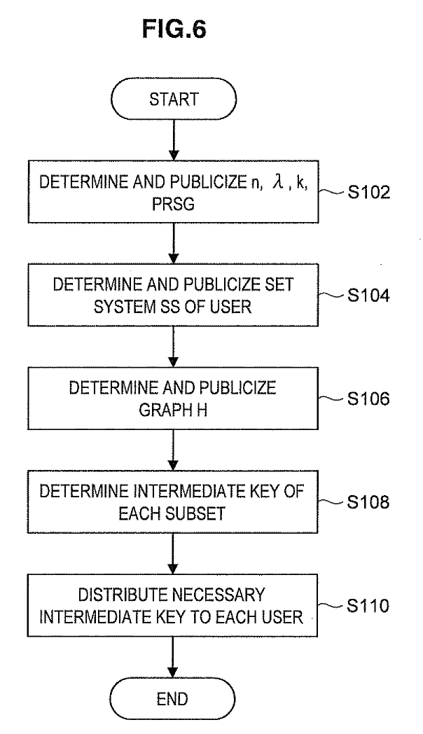

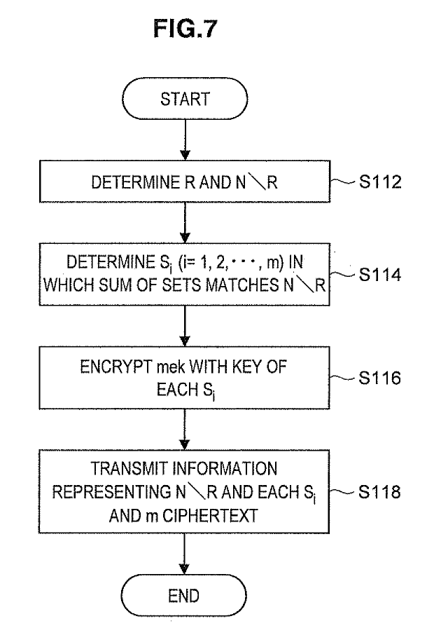

The key distribution method by the key distribution server 102 of the AI system will now be described with reference to FIGS. 6 and 7. FIG. 6 is an explanatory view showing a flow of key distribution process in system setup. FIG. 7 is an explanatory view showing a flow of process for distributing the content key.

### (Key Distribution Method in System Setup)

First, the key distribution method in system setup will be described with reference to FIG. 6.

As shown in FIG. 6, the key distribution server 102 determines the number of contractors n, number of bits λ of the set key and the intermediate key, a predetermined parameter k, and the pseudo-random sequence generation algorithm by PRSG, and the like, and publicizes the same to all the terminal devices 122 (S102). The key distribution server 102 divides the set of terminal device 122 to a predetermined subset, and then determines the set system SS (see equation (1)) expressed by the sum of sets, and publicizes the same to all the terminal devices 122 (S104). The key distribution server 102 determines the directed graph H formed by a plurality of directional branches E, and publicizes partial or entire information to all the terminal devices 122 (S106). The intermediate key corresponding to each subset configuring the set system SS is then determined (S108). The intermediate key for each terminal device 122 to derive the set key of all the subsets to which it belongs based on the directed graph is distributed to each terminal device 122 (S110).

As described above, a plurality of intermediate keys capable of deriving the set key of all the subsets including the relevant contractor is provided in advance to each contractor in system setup. The intermediate key capable of deriving the set key of the subset to which the contractor is not included may not be provided to each contractor. The number of intermediate keys to be provided to each contractor is preferably a minimum. A method of selecting the intermediate key will be briefly described below.

First, the key distribution server 102 extracts all diagraphs H capable of reaching the coordinate point of the subset in which the contractor u is included. If the contractor u is included in the subset corresponding to the route of the directed graph H, only the intermediate key corresponding to the relevant route is provided to the contractor u.

When the contractor u is included in one of the subsets corresponding to the coordinate point other than the of the route of the directed graph H, the key distribution server 102 extracts a subset S₀ in which the contractor u is included in the subset S₀ and not included in the subset parent (S₀) or the parent of the subset S₀. The intermediate key t(S₀) corresponding to such subset S₀ is then provided to the contractor u.

That is, when the contractor u is included in the subset corresponding to a plurality of coordinate points other than of the route of the directed graph H, the key distribution server 102 references the starting end of the directional branch reaching each coordinate point, and selects a coordinate point such that the subset corresponding to the starting end of each coordinate point does not include the contractor u. With the subset corresponding to such coordinate point as S₀, and the subset corresponding to the starting end (parent) of the directional branch reaching the coordinate point S₀ as parent (S₀), the key distribution server 102 provides the contractor u the intermediate key t(S₀) corresponding to the coordinate point S₀ such that the subset parent (S₀) corresponding to the parent coordinate point does not include the contractor u but the subset S₀ corresponding to the relevant coordinate point includes the contractor u. The starting end parent (S) of one directional branch is hereinafter expressed as the parent of the terminating end S of the directional branch. The parent of the coordinate point S₀ is noted as parent (S₀).

The key distribution server 102 also provides the contractor u a plurality of intermediate keys t(S₀) corresponding to a plurality of coordinate points S₀ if the coordinate point S₀ exists in plurals. The parent of the coordinate point S₀ obviously does not exist if the coordinate point S₀ is the route of the directed graph H. Only one parent of the coordinate point S₀ exists if the coordinate point S₀ is not the route of the directed graph H.

### Specific Example 1

The intermediate key distributed to the contractor 1 will be considered. First, the directed graph H that can reach the subset to which the contractor 1 is included is extracted. With reference to FIG. 5, the directed graph H is the directed graph H(1→64). The contractor 1 belongs to the subset [1, 1] corresponding to the route of the directed graph H(1→64). Therefore, the intermediate key t([1, 1]) is distributed to the contractor 1.

### Specific Example 2

The intermediate key distributed to the contractor 3 will be considered. First, the directed graph H that can reach the subset to which the contractor 3 is included is extracted. With reference to FIG. 5, such directed graph H is directed graph H (1∴64), H(2←64), H(2←32), H(2←16), H(2←8), H(2←4), H(3→3). Considering directed graph H(1→64) first, it can be seen that the contractor 3 is not included in the subset [1, 1] corresponding to the route of the directed graph H(1→64).

However, the contractor 3 is included in the subsets [1, 3], [1, 4], . . . , [1, 64] after the third coordinate point. It can be seen with reference to the subset of the parent of such coordinate points that the coordinate points that do not include the contractor 3 in the subset of the parent are only [1, 3] and [1, 4]. Therefore, the coordinate point [1, 2] corresponding to the parents parent ([1, 3]) and the parent ([1, 4]) of the coordinate points [1, 3], [1, 4] does not include the contractor 3.

As a result, the intermediate keys t([1, 3]) and t([1, 4]) corresponding to the directed graph H(1→64) are distributed to the contractor 3. Similarly, the intermediate key is selected for other directed graphs H(2←64), H(2←32), H(2←16), H(2←8), H(2←4), H(3→3) and distributed to the contractor 3. Consequently, a total of 8 intermediate keys are distributed to the contractor 3.

### (Method of Distributing Content Key)

A method of distributing the content key mek will now be described with reference to FIG. 7.

As shown in FIG. 7, the key distribution server 102 determines the set R of eliminated contractors, and determines the set N\R of permitted contractors (S112). Thereafter, m subsets Sᵢ(i=1, 2, . . . , m) in which the sum of sets becomes N\R are selected from the subsets configuring the set system SS (S114). The content keys mek are respectively encrypted using the set key k(Sᵢ) corresponding to each selected subset Sᵢ (S116). The information representing the set N\R or each subset Sᵢ, and the m encrypted content keys mek are distributed to all the terminal devices 122 (S118).

The key distribution method in setup and the distribution method of the content key mek by the key distribution server 102 have been described above. According to such distribution methods, the intermediate key for each permitted contractor to generate the set key can be efficiently distributed.

### [Decryption Method of Content Key]

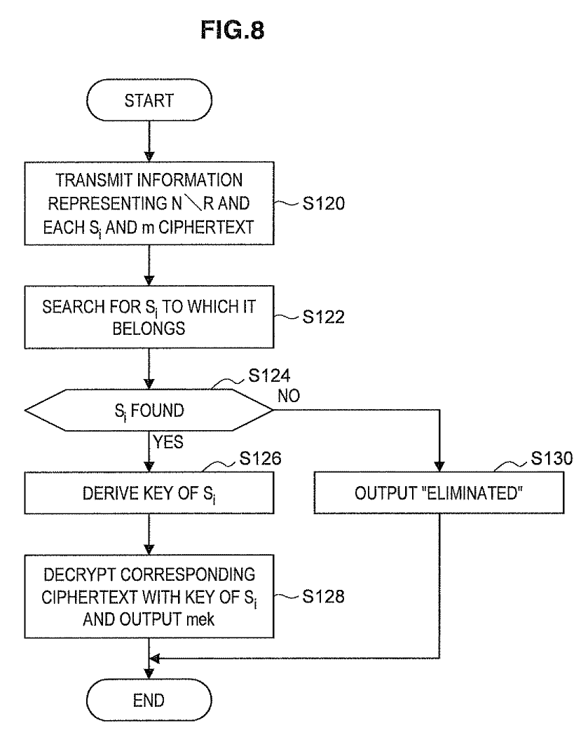

A process of decrypting the content key mek encrypted by the terminal device 122 will now be described with reference to FIG. 8. FIG. 8 is an explanatory view showing a flow of the decryption process of the content key by the terminal device 122.

As shown in FIG. 8, the terminal device 122 acquires the m encrypted content keys mek from the key distribution server 102, and the information representing the set N\R or the information representing m subsets Sᵢ(i=1, 2, . . . , m) (S120). The terminal device 122 then searches for the subset Sᵢ to which it is included (S122), and determines whether or not included in one of the m subsets Sᵢ (S124). If a subset Sᵢ to which it is included exists, the terminal device 122 uses the pseudo-random sequence generator PRSG and derives the set key k(Sᵢ) corresponding to such subset Sᵢ (S126). The terminal device 122 then decrypts the encrypted content key mek using the derived set key k(Sᵢ) (S128). If not included in any of the subsets Sᵢ, the terminal device 122 displays and outputs a notification of being the eliminated contractor (S130), and the decryption process of the content key is terminated.

As described above, the terminal device 122 can decrypt the content key mek based on the information of the set N\R or the m subsets Sᵢ acquired from the key distribution server 102, and the m encrypted content keys k(Sᵢ).

### [Generation Method of Directed Graph H]

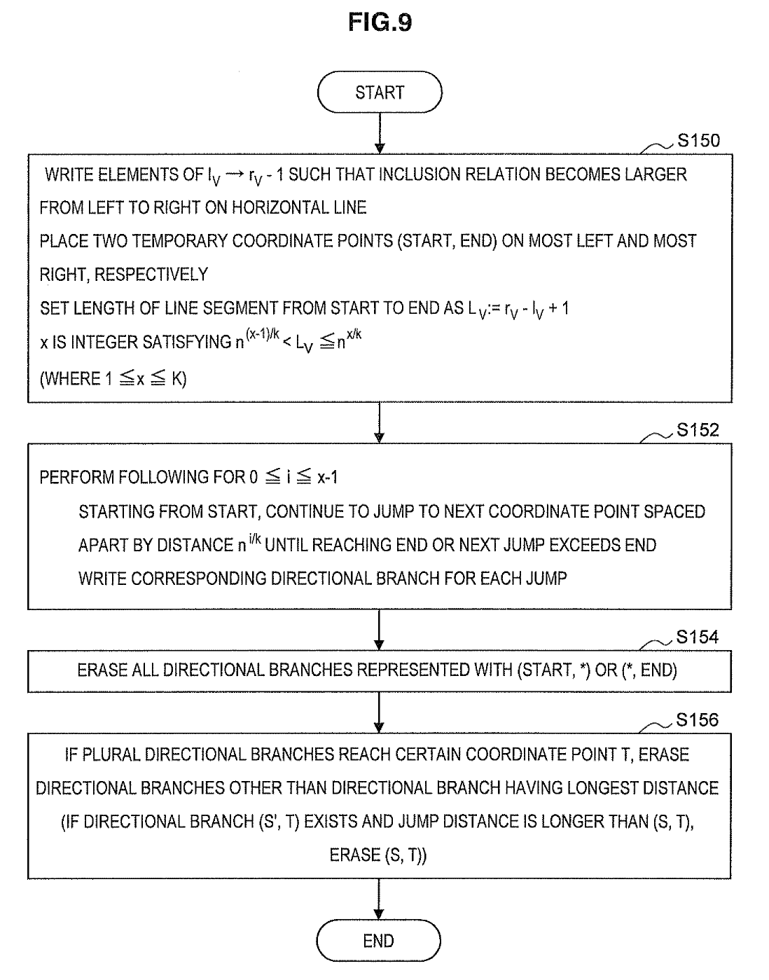

A generation method of the directed graph H will be described with reference to FIG. 9. FIG. 9 is an explanatory view showing a flow of the generation process of the directed graph H(lᵥ→rᵥ−1).

As shown in FIG. 9, the coordinate axis setting unit 106 arranges the elements of the set (lᵥ→rᵥ−1) such that the inclusion relation becomes larger from the left to the right on the horizontal line. One temporary coordinate point Start is then arranged on the left side of the left most coordinate point, and one temporary coordinate point End is arranged on the right side of the right most coordinate point. The length from the temporary coordinate point Start to the temporary coordinate point End then becomes Lᵥ=rᵥ−lᵥ+1. Furthermore, an integer x (1≦x≦k) satisfying n^{(x-1)/k}<Lᵥ≦n^{x/k} is calculated (S150).

The directed graph generation unit 110 then performs the following operation while moving the counter i from 0 to x−1. Starting from the temporary coordinate point Start, jump is continuously made from such coordinate point to the coordinate point spaced apart by n^{1/k} until reaching the temporary coordinate point End or when the next jump exceeds the temporary coordinate point End. The directional branch corresponding to each jump is then generated (S152). The directional branches reaching the temporary coordinate point Start or End are all erased (S154). If the directional branch reaching a certain coordinate point T is in plurals, the directional branches other than the directional branch having the longest jump distance are erased (S156).

The generation method of the directed graph H of the AI system has been described.

### Key Setting Method According to the Present Embodiment

The key setting method according to the present embodiment will be described in view of the generation method of the directed graph H by the AI system and the key distribution method. The key setting method according to the present embodiment takes in the technical idea of the hierarchical ID base encryption (HIBE) system into the technique of the AI system to extent the public key encryption system. It is not easy to integrate the HIBE system and the AI system, and devisal is desired to realize such extension.

### (Function Configuration of Information Processing Device 150)

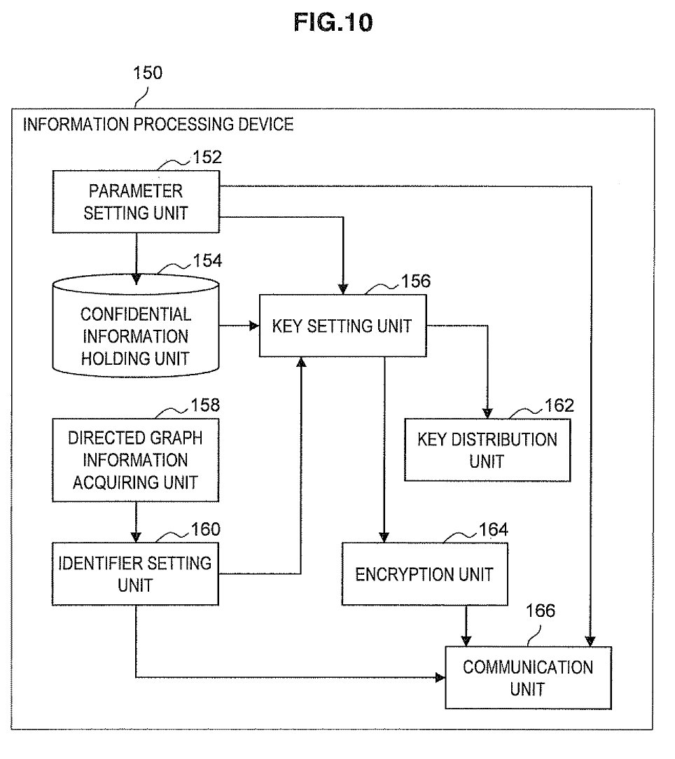

First, the function configuration of the information processing device 150 according to the present embodiment will be described with reference to FIG. 10. FIG. 10 is an explanatory view showing the function configuration of the information processing device 150 according to the present embodiment. The information processing device 150 is a setting device for realizing such extension, and may be installed in the key distribution server 102 or may be configured as a separate body.

As shown in FIG. 10, the information processing device 150 is mainly configured by a parameter setting unit 152, a confidential information holding unit 154, a key setting unit 156, a directed graph information acquiring unit 158, an identifier setting unit 160, a key distribution unit 162, an encryption unit 164, and a communication unit 166.

### (Parameter Setting Unit 152)

The parameter setting unit 152 is a section for setting a parameter for determining the identifier (ID) to be assigned to each node of the directed graph H. First, the parameter setting unit 152 sets the parameters n, λ, k similar to the key distribution server 102. The parameter setting unit 152 then sets multiplicative groups G and G₁ of order q (q is an integer). The parameter setting unit 152 sets a bilinear mapping e: G×G→G₁ defined below.

### (Definition of Bilinear Mapping e)

(1) Have bilinear property. That is, e(P^{a}, Q^{b})=e(P,Q)^{ab} is satisfied with respect to arbitrary P, QεG and arbitrary a, bεZ.

(2) Have non-degenerative property. That is, if P is the generator of G, e(P, P) is the generator of G₁.

(3) Have computability. That is, an efficient algorithm for calculating e(P, Q) exists with respect to the arbitrary P, QεG.

The parameter setting unit 152 the sets an arbitrary generator belonging to the multiplicative group H and a random value αεZ_{q}*. The parameter setting unit 152 then sets g₁ where g₁=g^{α}. The parameter setting unit 152 sets random values g₂, g₃, h₁, . . . , h₁εG. Here, 1 is the number 1=(2k−1)(n^{1/k}−1)+1 in which 1 is added to the length (2k−1)(n^{1/k}−1) of the maximum bidirectional branch in the directed graph H in the AI system. The parameter setting unit 152 saves the g₂^{α} in the confidential information holding unit 154. The parameter setting unit 152 inputs the parameter to publicize (hereinafter HIBE public, see equation (4)) HIBE-params of the set parameters to the communication unit 166, and publicizes the same to the communication unit 166 or the other sections. Each parameter is input to the key setting unit 156.

HIBE-params=(G, G₁, e, g, g₁, g₂, g₃, h₁, . . . , h₁) eq. (4)

### (Identifier Setting Unit 160)

The identifier setting unit 160 is a section for assigning an identifier to the directed graph H and each node of the directed graph H based on the information related to the directed graph H of the AI system acquired by the directed graph information acquiring unit 158.

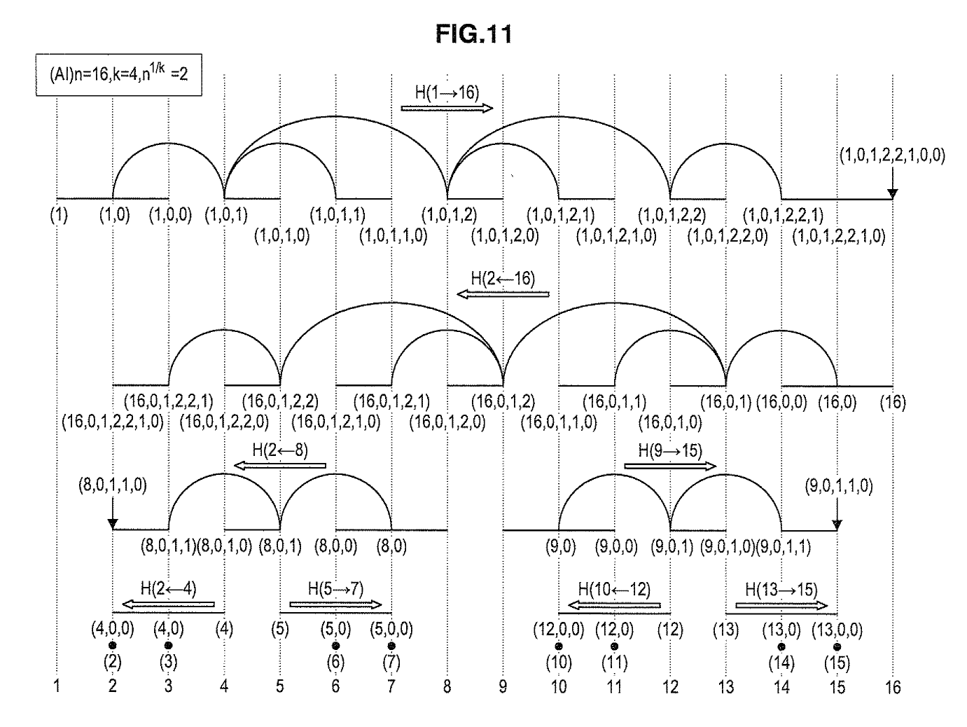

A method of assigning the identifier will be described with reference to FIG. 11. FIG. 11 is an explanatory view showing the method of assigning the identifier according to the present embodiment. The example of FIG. 11 shows a method of assigning the identifier to the directed graph H of the AI system when n=16, k=4, n^{1/k}=2.

FIG. 11 shows sixteen directed graphs H. Each directed graph H has different number for the vertical line intersecting the starting point, and thus can be specified by such number. For instance, the directed graph H(1→16) is specified with the number 1. Similarly, the directed graph H(2←16) is specified with the number 16. The identifier setting unit 160 sets the number of the vertical line intersecting the starting point of each directed graph H as an identifier (hereinafter referred to as first identifier) of the starting point node. Each directed graph H is specified by the first identifier. For instance, the first identifier indicating the starting point node [16, 16] of the directed graph H(2←16) is 16. The identifier is hereinafter expressed as ( . . . ).

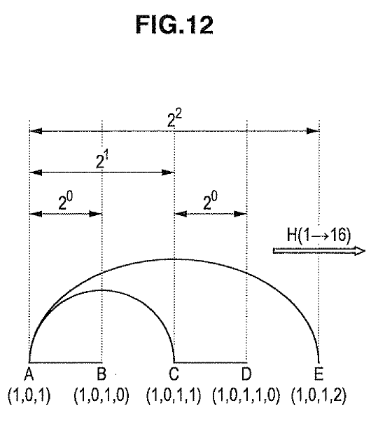

In order to identify a certain node with respect to the directed graph H, the identifier setting unit 160 then expresses the identifier using the length of the directional branch connecting the relevant node and the parent node. For instance, the identifier setting unit 160 adds the information (hereinafter referred to as second identifier) on to what power the length of the directional branch is of n^{1/k} to the first identifier, and sets the identifier of each node. With reference to the example of FIG. 12, one child node [1, 2] exists for the starting point node [1, 1] of the directed graph H(1→16), and the length of the directional branch connecting the [1, 1] and the [1, 2] is n^{1/k}=2⁰, and thus the identifier of the child node [1, 2] is expressed as (1, 0) using the first identifier and the second identifier.

FIG. 12 shows in more detail the method of setting the identifier. In FIG. 12, one part of the directed graph H(1→16) is extracted. With reference to the A point of FIG. 12, the directional branch extends from the A point to the B point, the C point, and the E point. The directional branch also extends from the C point to the D point.

Since the identifier of the A point is (1, 0, 1), the identifier of the B point is (1, 0, 1, 0) based on the length 2⁰ of the directional branch between AB points. Similarly, the identifier of the C point is (1, 0, 1, 1), and the identifier of the E point is (1, 0, 1, 2). The identifier of the D point is (1, 0, 1, 1, 0) added with 0 (length 2⁰ of directional branch) to the identifier of the C point (1, 0, 1, 1), which is the parent node.

Reference is again made to FIG. 10. The identifier setting unit 160 sets the identifier to all the nodes of all the directed graphs H through the above method. The identifier setting unit 160 publicizes the assignment rule of the identifier to the communication unit 166 or other sections after setting all the identifiers.

If the identifier ID is expressed as ID=(I₁, . . . , I_{W}), the first element I₁ is I₁ε{1, 2, . . . , n}, and the second and subsequent elements I_{w}(2≦w≦W) are I_{w}ε{0, 1, k−1}. Since all nodes on the directed graph H can be formed with the directional branch of less than or equal to (2k−1)(n^{1/k}−1), W≦1=(2k−1)(n^{1/k}−1)+1 is obtained. I_{w}εZ_{q} is obtained by setting the order q large.

### (Key Setting Unit 156)

The key setting unit 156 is a section for deriving the key corresponding to each subset based on the parameter set by the parameter setting unit 152 and the information of the identifier set by the identifier setting unit 160. First, the key setting unit 156 sets a random value yεZ_{q}. The key setting unit 156 then derives the key k(S₍₁₁₎) of the subset corresponding to the starting point node of the directed graph H in the following manner (see equation (5)).

(g₂^{α}·(h₁^{I1}·g₃)^{y}, g^{y}, h₂^{y}, . . . , h₁^{y})εG¹⁺¹ eq. (5)

The key setting unit 156 sets the key of the subset corresponding to other nodes of each directed graph H. For instance, with respect to the node expressed with the identifier ID=(I₁, . . . , I_{w-1}), if the key of the subset corresponding to such node is k(S_{(I1, . . . , Iw-1)})=(a₀, a₁, b_{w}, . . . , b₁), the key k(S_{(I1, . . . , Iw)}) of the child node expressed with the identifier ID=(I₁, . . . , I_{w}) is derived in the following manner using a random value y′εZ_{q} (see equation (6)).

a₀·b_{w}^{Iw}·(h₁^{I1} . . . h_{w}^{Iw}·g₃)^{y′},a₁·g^{y′},b_{w+1}·h_{w+1}^{y′}, . . . , b₁·h₁^{y′})εG^{2+1-w} eq. (6)

In the information processing device 150, the key setting unit 156 executes a key deriving process of the child node. However, the key of the child can be derived from the key of a certain node even in the terminal device 122. The key of the starting point node of each directed graph H is only derived by the information processing device 150 which knows the parameter g₂^{α}. The parameter y′ used when deriving the key of the child node may differ between the terminal devices 122 or may differ between the terminal device 122 and the information processing device 150.

### (Key Distribution Unit 162)

The key distribution unit 162 is a section for distributing the key of each subset set by the key setting unit 156 to the terminal device 122. First, the key distribution unit 162 extracts all directed graphs H having the subset to which the user u belongs as the element. If the user u is included in the subset corresponding to the starting point node of the directed graph H, the key distribution unit 162 provides only the key of the subset corresponding to the route of the directed graph H to the terminal device 122 of the user u.

If the user u is included in the subset corresponding to the node other than the starting point node of the directed graph H, the key distribution unit 162 extracts a subset S to which the user u is included, where in such subset S, the user u is not included in the subset parent (S) of the parent node. The key distribution unit 162 provides the key k(S) of the extracted subset S to the terminal device 122 of the user u. If a plurality of subsets exists in one directed graph H, the key of each subset S is provided to the terminal device 122 of the user u.

In the case of FIG. 11 (n=16, k=4), the user 1 belongs to the subset [1, 1]=S₍₁₎ of the starting point node of the directed graph H(1→16), and thus the key distribution unit 162 provides only the key k([1, 1])=k(S₍₁₎) of the subset [1, 1] to the user 1. The user 3 belongs to the directed graphs H(1→16), H(2←16), H(2←8), H(2←4), H(3→3). With reference to the directed graph H(1→16), for example, two subsets in which the user 3 does not belong to the subset of the parent node exists of the subsets to which the user 3 belongs ([1, 3]=S_{(1, 0, 0)}, [1,4]=S_{(1, 0, 1)}). Thus, the key distribution unit 162 provides the keys of two subsets to the terminal device 122 of the user 3 with respect to the directed graph H(1→16). The key distribution unit 162 similarly provides the key of the subset with respect to other directed graphs H. In the case of this example, the key distribution unit 162 provides a total of five keys to the terminal device 122 of the user 3.

### (Encryption Unit 164)

FIG. 10 is again referenced. The encryption unit 164 is a section for encrypting the content key mek or other information and generating an cipher text. First, the encryption unit 164 sets a random value sεZ_{q}. If M=mek, MεG₁, and identifier of the subset of the distribution object (key) is ID=(I₁, . . . , I_{w}), the encryption unit 164 outputs an cipher text CT in the following manner (see equation (7)). The encryption unit 164 outputs similar cipher text CT to each subset or distribution object. The output cipher text is provided to the user via the communication unit 166 or other sections with the information of the subset.

CT=(e(g₁, g₂)^{s}·M,g^{s},(h₁^{I1} . . . h_{W}^{IW}·g₃)^{s})εG₁×G² eq. (7)

The function configuration of the information processing device 150 according to the present embodiment has been described. The technique related to the present embodiment has main features in the function configuration of the information processing device 150, and is realized in combination with the function of the key distribution server 102.

### [Flow of Key Setting Process]

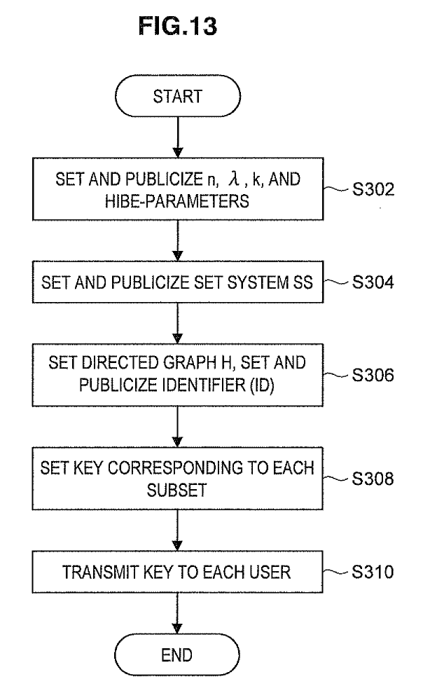

The flow of the key setting process according to the present embodiment will be briefly described with reference to FIG. 13. FIG. 13 is an explanatory view showing the flow of the key setting process according to the present embodiment.

As shown in FIG. 13, n, λ, k, and HIBE-params are set and publicized as public parameters (S302). The set system SS is then set and publicized (S304). The directed graph H is set (generated), and the identifier is set and publicized to each node of the directed graph H (S306). The key corresponding to each subset is set (derived) (S308). A predetermined key is provided (transmitted) to the terminal device 122 of each user (S310). The key setting process is executed according to the above flow.

### [Flow of Key Distribution Process]

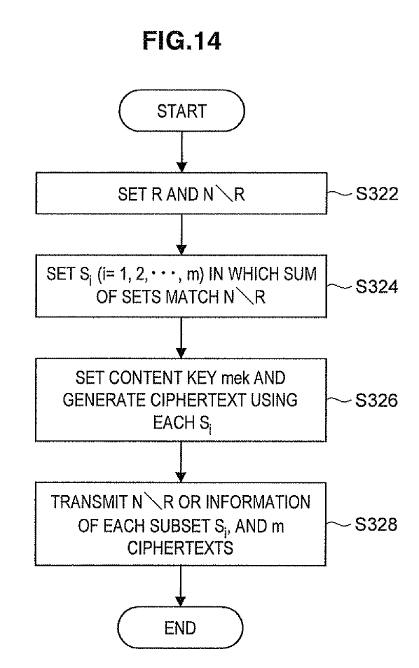

The flow of the key distribution process according to the present embodiment will be briefly described with reference to FIG. 14. FIG. 14 is an explanatory view showing the flow of the key distribution process according to the present embodiment.

As shown in FIG. 14, the set R of the eliminated contractor and the set N\R of the permitted contractor are set (S322). Then, m subsets S in which the sum of sets match the set N\R of the permitted contractor match are set (S324). The content key mek is set, and the cipher text is generated for each set subset Si (S326). The set N\R of the permitted contractor or the information of each subset Si, and m cipher texts are transmitted (S328). The key distribution process is executed according to the above flow.

### [Regarding Decryption Process]

The decryption process according to the present embodiment will be described. The decryption process according to the present embodiment is similar to the AI system, but differs in the method of deriving the key corresponding to the subset and the method of decrypting the cipher text using the key of the subset after detecting the subset to which it belongs.

When detecting the subset Si to which it belongs from the subsets or the distribution object, the terminal device 122 of a certain user derives the key k(Si) corresponding to the subset Si. The key k(Si) is sometimes provided to the terminal device 122 in advance. In this case, the terminal device 122 decrypts the cipher text using the key k(Si) provided in advance. If the key k(Si) is not provided in advance, the terminal device 122 derives the key k(Si) through the following procedures.

If the identifier ID of the subset Si is (I₁, . . . , I_{W}), the terminal device 122 provides the key of ID=(I₁, . . . , I_{w})(w≦W) in advance. If w=W, the desired key k(Si) is already held. The terminal device 122 derives the key of (I₁, . . . , I_{w}, I_{w+1}) using the key of ID=(I₁, . . . , I_{w})(w≦W) according to equation (6). The terminal device 122 derives the key k(Si) of (I₁, . . . , I_{W}) by repeating the derivation process.

After the key k(Si) is derived, the terminal key 122 decrypts the cipher text using the key k(Si). The terminal device 122 first sets the value zεZ_{q}. Representing the key k(Si) (see equation (8), and the cipher text CT (see equation (9)) as below, the terminal device 122 decrypts the cipher text using equation (10) and derives the content key M=mek.

$$\begin{matrix}\begin{matrix}k ( Si ) = ( {g}_{2}^{α} \cdot {( {h}_{1}^{I 1} … {h}_{W}^{IW} \cdot {g}_{3} )}^{z} , {g}^{z} , {h}_{W + 1}^{z} , … , {h}_{1}^{z} ) \\ = ( {a}_{0} , {a}_{1} , {b}_{W + 1} , … , {b}_{1} )\end{matrix} & eq . ( 8 ) \\ CT = ( {e ( {g}_{1} , {g}_{2} )}^{s} \cdot M , {g}^{s} , {( {h}_{1}^{I 1} … {h}_{W}^{IW} \cdot {g}_{3} )}^{s} ) = ( A , B , C ) & eq . ( 9 ) \\ M = A \cdot e ( {a}_{1} , C ) / e ( B , {a}_{0} ) & eq . ( 10 )\end{matrix}$$

### [Regarding Selection of Common Key System and Public Key System]

The broadcast encryption system of the public key encryption system is realized by applying the technique of the present embodiment as described above. The technique according to the present embodiment is based on the common key encryption system, and thus the common key encryption system and the public key encryption system may be selectively used depending on the situation.

Consider the following case. Suppose an entity configured by one teacher and plural students is a class connected to each other with a network. The students are divided into groups of few people. The answers to the test problems distributed by the teacher are being discussed and obtained by groups. The teacher is reliable, and is able to know the key held by the students. The broadcast encryption system of the common key encryption system such as AI system is used when the teacher distributes the test problems to the students. The broadcast encryption system of the public key encryption system may also be used, but more calculation will becomes necessary than the common key encryption system.

Assume a case where the answers to the test problems are discussed among the students in the group. In this case, the students of each group create or edit the answer file so as to again be shared among the students of the group. In this case, if the common key encryption system is used, each student has credence to an extent the key of another person may be known. It is often difficult to realize such request. In such case, the broadcast encryption system of the public key encryption system is suitable. If the public key encryption system is used, the transmitter may not know the private key of the receiver.

Therefore, the common key encryption system and the public key encryption system are preferably used according to purpose or situation. In this regards, the present embodiment is based on the technique of the common key encryption system and is extended to the public key encryption system, and thus switching between the systems is easily realized, and the device configuration can be simplified compared to when individually preparing the device of the common key encryption system and the device of the public key encryption system. The setting of the directed graph, the setting of the subset to which each user belongs, and the like are made common, and thus the mounting cost and the like can be reduced as a whole.

### Application Example of Key Distribution System 100

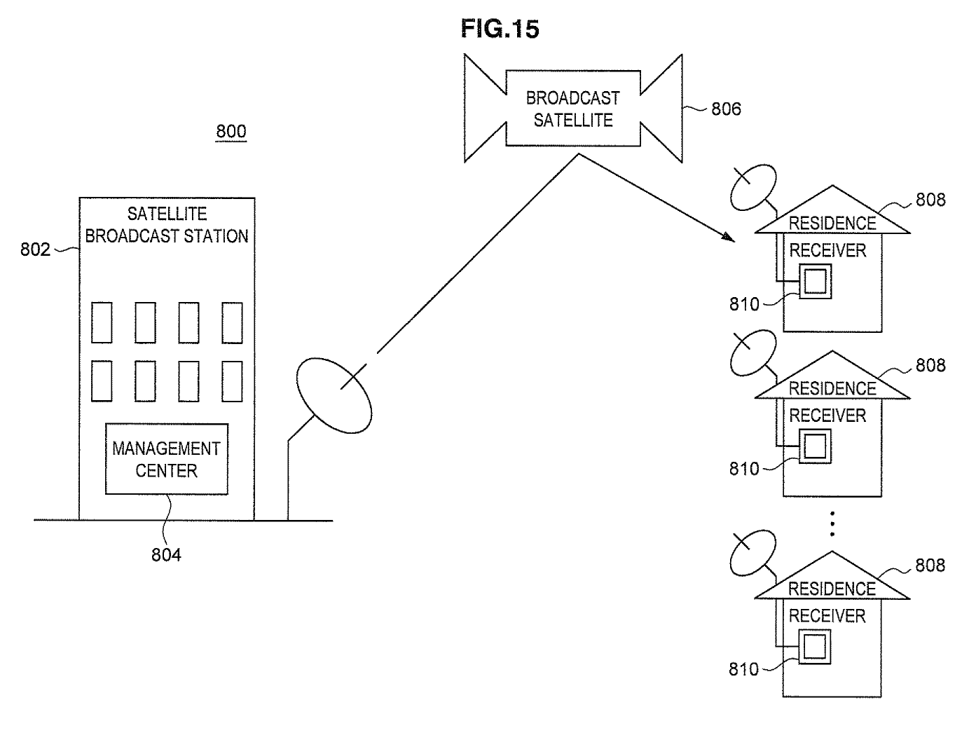

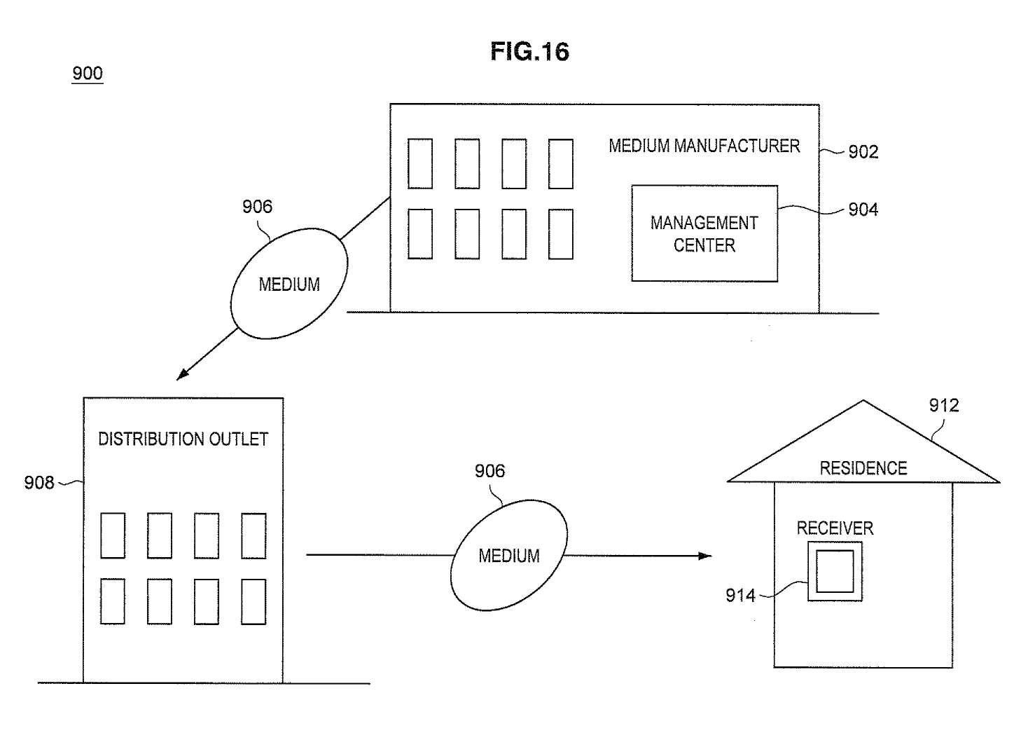

The application example of the key distribution system 100 according to each embodiment above will be briefly described with reference to FIGS. 15 and 16.

### Application Example 1

First, a configuration of a broadcast encryption system 800 will be described as one application example of the key distribution system 100. FIG. 15 is an explanatory view showing a configuration of the broadcast encryption system 800 using broadcast satellite.

With reference to FIG. 15, the broadcast encryption system 800 is mainly configured with a satellite broadcast station 802, a management center 804, a broadcast satellite 806, a residence 808, and a receiver 810. The broadcast encryption system 800 is a system for distributing the encrypted data (cipher text) to the receiver 810 arranged in the residence 808 via the broadcast channel. The broadcast channel is a satellite broadcast distribution channel, and the like. The cipher text is a content including encryption key, audio data, video data, text data, or the like.

The satellite broadcast station 802 is arranged with the management center (broadcast trusted center) 804 for transmitting data such as cipher text via the broadcast satellite 806. The management center 804 selects the key for encryption, and executes encryption of data and distribution control of data. That is, the management center 804 is one example of the key distribution server 102 according to each embodiment above. The receiver 810 installed in the residence 80 is one example of the terminal device 122 according to each embodiment above.

The broadcast satellite 806 broadcasts data such as cipher text to the receiver 810 through the management center 804 and the receiver 180 arranged in each residence 808. The receiver 810 is a satellite broadcast receiver and the like, and receives data broadcasted through the broadcast satellite 806. As shown in FIG. 15, the broadcast encryption system 800 may include plural receivers 810, in which case the management center 804 distributes data to the receiver group consisting of plural receivers 810. The management center 804 encrypts and distributes the broadcast data so that only the authenticated receiver 810 can decrypt the data.

The broadcast encryption system 800 serving as one application example of the key distribution system 100 has been described above. In FIG. 15, the satellite broadcast has been described by way of example, but the broadcast encryption system 800 is also easily applicable to the encryption system using other broadcast channels such as cable television and computer network.

### Application Example 2

A configuration of a broadcast encryption system 900 will be described as another application example of the key distribution system 100. FIG. 16 is an explanatory view showing a configuration of the broadcast encryption system 900 using a recording medium.

With reference to FIG. 16, the broadcast encryption system 900 is mainly configured by a medium manufacturer 902, a management center 904, a recording medium 906, a distribution outlet 908, a residence 912, and a receiver 914. The broadcast channel in the broadcast encryption system 900 is a recording medium 906 recorded with data.

First, the medium manufacturer 902 is arranged with the management center 904 for providing data such as cipher text to the residence 912 via the distribution outlet 908 using the recording medium 906. The management center 904 merely records data such as cipher text in the recording medium 906, and indirectly provides data such as cipher text using the recording medium 906. The recording medium 906 is a read-only medium (e.g., CD-ROM, DVD-ROM etc.), rewritable medium (e.g., CD-RW, DVD-RW, etc.), or the like. Similar to the application example 1, the management center 904 corresponds to the key distribution server 102 according to each embodiment above. There is a slight difference in that the data such as cipher text is recorded and provided in the recording medium, but the key distribution server according to the embodiment of the present invention can appropriately change a section for distributing information such as cipher text according to the embodiment as in this application example.

The medium manufacturer 902 sends the recording medium 906 recorded with data such as cipher text to the distribution outlet 908 such as retailer. The distribution outlet 908 then provides the medium 906 to each residence 912. For instance, the distribution outlet 908 sells the recording medium 906 to the individual corresponding to each residence 912. The individual carries home the recording medium 906 to the residence 912, and reproduces the data recorded on the recording medium 906 using the receiver 914. The receiver 914 is one example of the terminal device 122 according to each embodiment, and slightly differs in acquiring the data such as cipher text through the recording medium. However, the terminal device according to the embodiment of the present invention can appropriately change the section for acquiring the information such as cipher text according to the embodiment as in this application example. The receiver 914 is a CD player, a DVD player, or a computer equipped with the DVD-RW driver, and is configured by a device capable of reading out and reproducing the data recorded on the recording medium 906.

The broadcast encryption system 900 serving as one application example of the key distribution system 100 has been described above. In FIG. 16, the section for providing the data such as cipher text to the contractor through the recording medium 906 has been described by way of example. The key distribution server and the terminal device according to the embodiment of the present invention can change the configuration related to the distribution section of various information according to the embodiment.

### Second Embodiment

A specific system related to a configuration and a key distribution of a key distribution system 100 according to a second embodiment of the present invention will be described in detail with reference to the drawings. Same reference numerals are denoted for the components substantially the same as the key distribution system 100 according to the first embodiment to omit redundant explanation, and the different components will be described in detail.

### Features of Second Embodiment

The difference between the embodiments will be made clear by describing the second embodiment of the present invention in comparison to the first embodiment, thereby clarifying the features of the second embodiment. First, the largest difference between the first embodiment and the present embodiment lies in the difference in the underlying key distribution system. The first embodiment is based on the AI system, whereas the present embodiment is applied to the RC system.

### (Comparing AI System and RC System)

The difference between the AI system and the RC system will be briefly described to clarify the features of the RC system. The difference between the AI system and the RC system lies in the amount of calculation for key generation, as described at the beginning of the specification. Specifically, the difference is as described below.

As described in the explanation of the first embodiment, in the AI system, the directed graphs H(1→n) and H(2←n) are corresponded to the root node of the binary tree BT, and the directed graph H(lᵥ→rᵥ−1) or H(lᵥ+1←rᵥ) is corresponded to the other intermediate node v. The directed graph H to which the contractor u may belong is one of the two directed graphs corresponded to each one of the log(n)−1 intermediate node v(v=1, . . . , log(n)−1) excluding the leaf node and the root node, and the root node of the nodes existing on the path from the leaf node u to the root node of the binary tree BT. Therefore, a maximum of log(n)+1 directed graphs H exist in total. With respect to each directed graph H, the maximum value of the number of keys to be held by the contractor is smaller than or equal to the maximum number of directional branches contained in the directional path having a certain coordinate point as the starting point. Since the maximum number of directional branches is equal to the parameter k, the number of keys to be held by each contractor becomes smaller than or equal to k*(iog(n)+1) in the worst case. This gradually approaches O(k*log(n)).

More specifically, the value is obtained by calculating x(1≦x≦k) which satisfies n^{(x-1)/k}<Lv≦n^{x/k} for the length Lᵥ of the line segment used in generating the directed graph H. Calculating x for each intermediate node on the binary tree BT, the upper limit of the number of keys to be held by each contractor can be expressed with the following equation (11). One issue in that the amount of calculation of each contractor is still large arises as a result in the AI system.

$${\sum }_{x = 1}^{k - 1} x ( \frac{log n}{k} ) + k ( \frac{log n}{k} - 1 ) + 2 k = \frac{( k + 1 )}{2} log n + k \qquad eq . ( 11 )$$

The amount of calculation for each contractor to generate the set key will be reviewed. The dominant factor for determining the amount of calculation on each contractor is the number of calculations of the PRSG for generating the desired intermediate key. The worst value is expressed by the number of directional branches contained in the directional path from the route of the directed graph H to the most distant leaf (coordinate point from which the directional branch does not extend). The worst value becomes the maximum for the directional path from the coordinate [1, 1] to [1, n] of the directed graph H(1→n). Suppose, t=n^{1/k}−1, and expressing the process of continuously executing the jump of distance b (correspond to directional branch) for a times as J(a, b), the directional path is expressed as in the following equation (12). This is the same for the system that does not use PRSG.

J(t,1),J(t,n^{1/k}), . . . , J(t,n^{(k-2)/k}),J(t−1, n^{(k-1)/k}), J(t, n^{(k-2)/k}) J(t, n^{1/k}), J(t+1,1) eq. (12)

That is, the number of directional branches (number of jumps) configuring the directional path is as expressed with equation (13). For instance, if the number of contractors is n=64 and the parameter is k=6, eleven directional branches exist on the directional path from the coordinate point [1, 1] to [1, 64] of the directed graph H(1→64). Thus, another issue is that since the number of directional branches is large in the AI system, the number of jumps, that is, the amount of calculation to be executed by each contractor is still large.

2(k−1)(n^{1/k}−1)+n^{1/k}−2+1=(2k−1)(n^{1/k}−1) eq. (13)

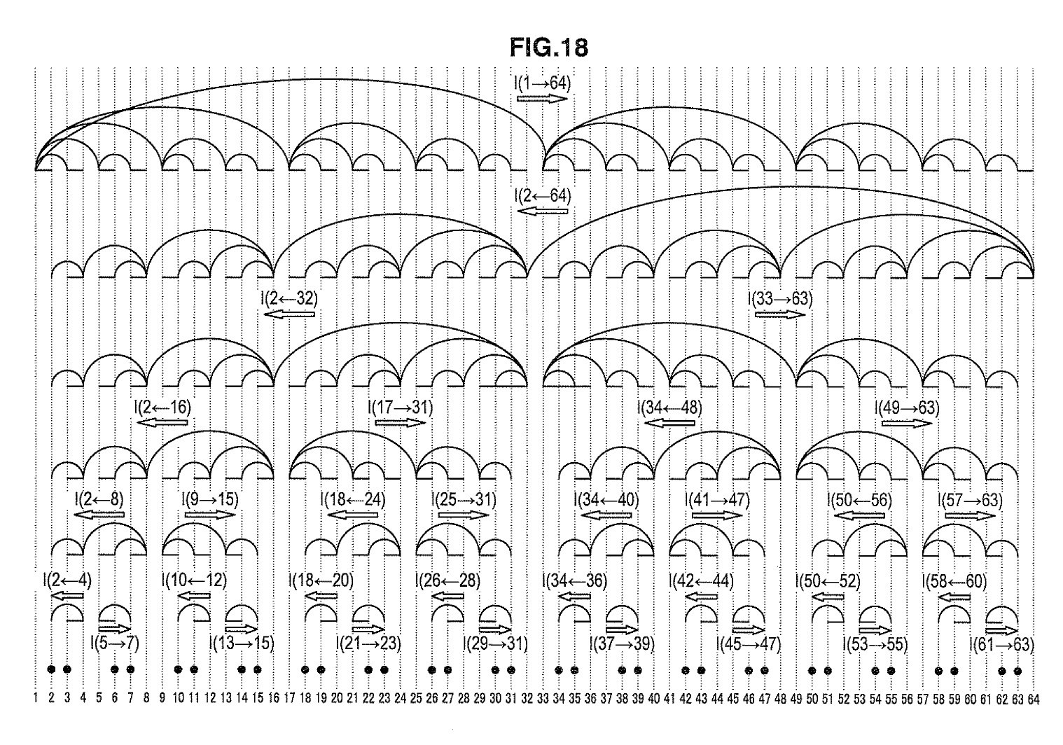

In the RC system, on the other hand, the feature lies in that modification is made such that the directed graph is configured with longer directional branches. For instance, FIG. 18 shows a directed graph I of the RC system, where it can be easily recognized that the directional branches of longer length is included compared to the directed graph H of the AI system shown in FIG. 5. Such directed graphs are both obviously configured based on the same binary tree BT, and the number of contractors n and the parameters k are also the same. As a result, it can be intuitively recognized that the amount of calculation on each contractor can be reduced compared to the AI system by applying the RC system.

Expressing the directional path from the coordinate point [1, 1] to [1, n] of the directed graph I(1→n) of the RC system similar to equation (12), equation (14) is obtained. The definition of J(a, b) is the same as the AI system.

J(t, n^{(k-1)/k}), J(t, n^{(k-2)/k}), . . . , J(t, n^{0/k}) eq. (14)

The number of directional branches (number of jumps) configuring the directional path is k*(n^{1/k}−1), which is reduced to about half compared to (2k−1)*(n^{1/k}−1) of the AI system. Thus, the amount of calculation on each contractor can be greatly reduced by applying the RC system. The present embodiment has features in the technique of extending the RC system or the common key system to the public key system, similar to the first embodiment. The present embodiment mainly differs in that the directed graph H of the AI system in the first embodiment is changed to the directed graph I of the RC system. The following description is made centering on such difference.

### [Configuration of Key Distribution System 100]

The configuration of the key distribution system 100 according to the present embodiment will be described. The basic system configuration is substantially the same as the configuration of the first embodiment shown in FIG. 1, and thus the detailed description will be omitted. The hardware configuration of a key distribution server 202 in the key distribution system 100 according to the present embodiment is also substantially the same as the hardware configuration of the key distribution server 102 shown in FIG. 2, and thus the detailed description will be omitted.

### [Function Configuration of Key Distribution Server 202]

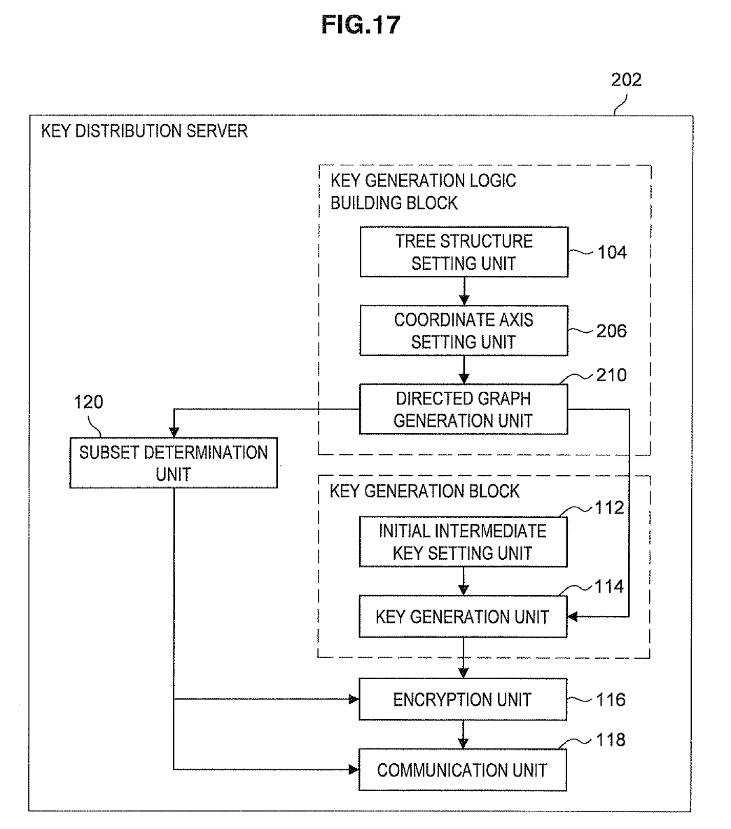

The function configuration of the key distribution server 202 according to the present embodiment will be described with reference to FIG. 17. FIG. 17 is an explanatory view showing the function configuration of the key distribution server 202.

As shown in FIG. 17, the key distribution server 202 is mainly configured with the tree structure setting unit 104, a coordinate axis setting unit 206, a directed graph generation unit 210, the initial intermediate key setting unit 112, the key generation unit 114, the encryption unit 116, the communication unit 118, and the subset determination unit 120. The distinguishing configuration of the present embodiment is mainly the coordinate axis setting unit 206 and the directed graph generation unit 210, and other components substantially the same as the components of the key distribution server 102 according to the first embodiment. Therefore, only the function configuration of the coordinate axis setting unit 206 and the directed graph generation unit 210 will be described in detail.

### (Coordinate Axis Setting Unit 206)

First, the function configuration of the coordinate axis setting unit 206 will be described. The coordinate axis setting unit 206 is a section for setting a plurality of horizontal coordinate axes for forming the directed graph I.

First, the coordinate axis setting unit 206 corresponds a plurality of subsets contained in the set (1→n−1) to each coordinate points on the one horizontal coordinate axis so that the inclusion relation becomes larger towards the right, and forms the horizontal coordinate axis of the set (1→n−1). The coordinate axis setting unit 206 corresponds a plurality of subsets contained in the set (lᵥ→rᵥ−1) associated with the intermediate node v to the coordinate points on the one horizontal coordinate axis so that the inclusion relation becomes larger towards the right with respect to the intermediate node v or v E BT_{R} on the binary tree BT, and forms the horizontal coordinate axis of the set (lᵥ→rᵥ−1). The coordinate axis setting unit 206 forms the horizontal coordinate axis of the set (lᵥ→rᵥ−1) with respect to all v or v εBT_{R}.

The coordinate axis setting unit 206 corresponds a plurality of subsets contained in the set (2←n) to each coordinate points on the one horizontal coordinate axis so that the inclusion relation becomes larger towards the left, and forms the horizontal coordinate axis of the set (2←n). The coordinate axis setting unit 206 corresponds a plurality of subsets contained in the set (lᵥ+1←rᵥ) to each coordinate point on the one horizontal coordinate axis so that the inclusion relation becomes larger towards the left, and forms the horizontal coordinate axis of the set (lᵥ+1←rᵥ). The coordinate axis setting unit 206 forms the horizontal coordinate axis of the set (lᵥ+1←rᵥ) with respect to all v or v εBT_{R}.

The coordinate axis setting unit 206 arranges two temporary coordinate points on the right side of the coordinate point positioned at the right end of the horizontal coordinate axis of the set (1→n−1). The coordinate axis setting unit 206 arranges two temporary coordinate points on the right side of the coordinate point positioned at the right end of the horizontal coordinate axis of the set (lᵥ→rᵥ−1). Furthermore, the coordinate axis setting unit 206 arranges two temporary coordinate points on the left side of the coordinate point positioned at the left end of the horizontal coordinate axis of the set (2←n). The coordinate axis setting unit 206 arranges two temporary coordinate points on the left side of the coordinate point positioned at the left end of the horizontal coordinate axis of the set (lᵥ+1←rᵥ).

The function configuration of the coordinate axis setting unit 206 has been described above. According to the above configuration, the coordinate axis setting unit 206 can generate a plurality of horizontal coordinate axes for forming the directed graph I of the RC system.

### (Directed Graph Generation Unit 210)

The function of the directed graph generation unit 210 will be described below. The directed graph generation unit 210 is a section for generating the directed graph I on each horizontal coordinate axis above.

First, the directed graph generation unit 210 sets the parameter k (k is an integer). The directed graph generation unit 210 determines the interval x satisfying n^{(x-1)/k}<rᵥ−lᵥ+1≦n^{x/k}. Assume k log(n) (base of log is 2). The parameter k is an amount related to the number of intermediate keys to be held by the terminal device 122, and the amount of calculation for generating the set key.

The directed graph generation unit 210 forms the directional branch facing the right direction having the length n^{i/k}(i=0 to x−1) on the horizontal coordinate axis of the set (1→n−1) and the horizontal coordinate axis of the set (lᵥ→rᵥ−1). Furthermore, the directed graph generation unit 210 forms the directional branch facing the right direction having the length n^{i/k}(i=0 to x−1) on the horizontal coordinate axis of the set (2←n) and the horizontal coordinate axis of the set (lᵥ+1←rᵥ). Similarly, the directed graph generation unit 210 forms the directional branch on the above horizontal coordinate axes corresponding to all v.

Specifically, the elements of the set (1→n−1) or the set (lᵥ→rᵥ−1) are lined so that the inclusion relation becomes larger from the left to the right on the horizontal line with respect to the horizontal coordinate axis of the set (1∴n−1) and the horizontal coordinate axis of the set (lᵥ→rᵥ−1). The left most coordinate point is the starting point. The two temporary coordinate points are arranged on the right of the right most coordinate point. The following operation is performed while moving the counter i from 0 to x−1. Starting from the starting point, jump is continuously made from such coordinate point to the coordinate point spaced apart by n^{i/k} until reaching the temporary coordinate point or when the next jump exceeds the temporary coordinate point. The directional branch corresponding to each jump is thereafter generated. It should be noted that similar process is performed on the horizontal coordinate axis of the set (2←n) and the set (lᵥ+1←rᵥ), but the directional branch is generated through the method having the left and the right reversed.

The directed graph generation unit 210 erases all the directional branches having the temporary coordinate point arranged on each horizontal coordinate axis as the starting end or the terminating end. The directed graph generation unit 210 erases all other directional branches leaving only the longest directional branch from the plurality of directional branches when the plurality of directional branches reach one coordinate point. Through the above processes, the directed graph H(1→n−1) of the set (1→n−1), the directed graph H (2←n) of the set (2←n), the directed graph H(lᵥ→rᵥ−1) of the set (lᵥ→rᵥ−1), and the directed graph H (lᵥ+1←rᵥ) of the set (lᵥ+1←rᵥ) are generated.

The directed graph generation unit 210 then adds the rightward directional branch having length of one having the temporary coordinate point positioned on the left side as the terminating end of the two temporary coordinate points arranged on the right side of the horizontal coordinate axis of the set (1→n−1) to the directed graph H(1→n−1). That is, the directed graph generation unit 210 executes the process of the following equation (15) and generates the directed graph H(1→n) of the set (1→n). E(H( . . . )) represents the set of the directional branches.

E(H(1→n))=E(H(1→n−1))∪{([1,n−1],[1,n])} eq. (15)

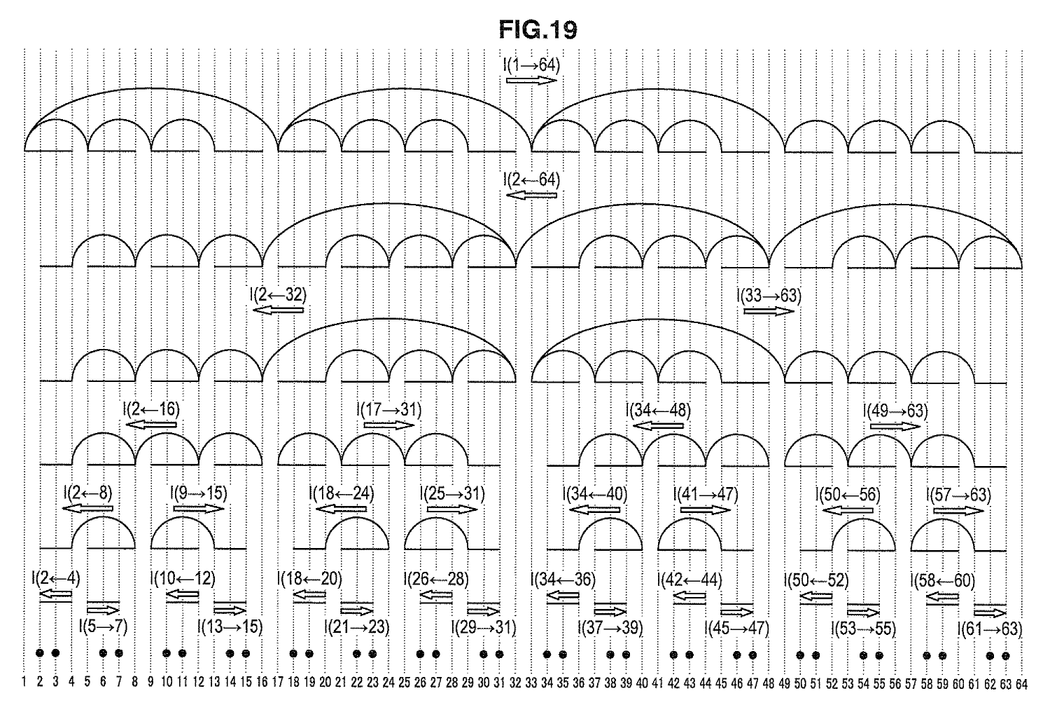

The functions configuration of the directed graph generation unit 210 have been described above. The directed graph I of the RC system as shown in FIG. 18 or FIG. 19 is thereby formed according to the above configuration.

### [Generation Method of Directed Graph I]

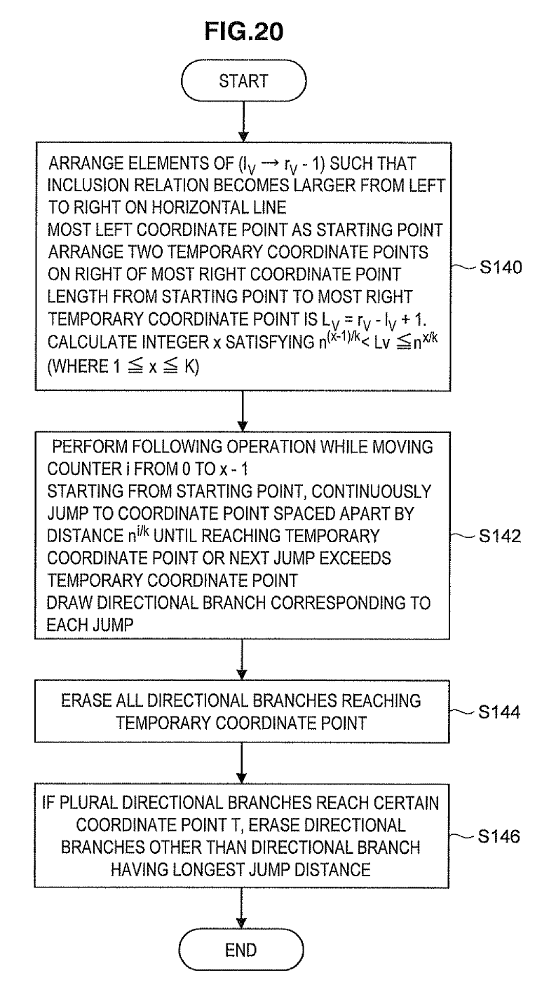

A generation method of the directed graph I will be described with reference to FIG. 20. FIG. 20 is an explanatory view showing a flow of the generation process of the directed graph I(lᵥ→rᵥ−1).

First, the elements of the set (lᵥ→rᵥ−1) are lined so that the inclusion relation becomes larger from the left to the right on the horizontal line. The left most coordinate point is the starting point. Two temporary coordinate points are arranged on the right of the right most coordinate point (S140). The length from the starting point to the right most temporary coordinate point is Lᵥ=rᵥ−lᵥ+1. An integer x (1≦x≦k) satisfying n^{(x-1)}/k<Lᵥ≦n^{x/k} is then calculated. The following operation is then performed while moving the counter i from 0 to x−1. Starting from the starting point, jump is continuously made from such coordinate point to the coordinate point spaced apart by n^{1/k} until reaching the temporary coordinate point or when the next jump exceeds the temporary coordinate point. The directional branch corresponding to each jump is thereafter generated (S142). All the directional branches reaching the temporary coordinate point are then erased (S144). If a plurality of directional branches reach a certain coordinate point T, the directional branches other than the directional branch having the longest jump distance are erased (S146).

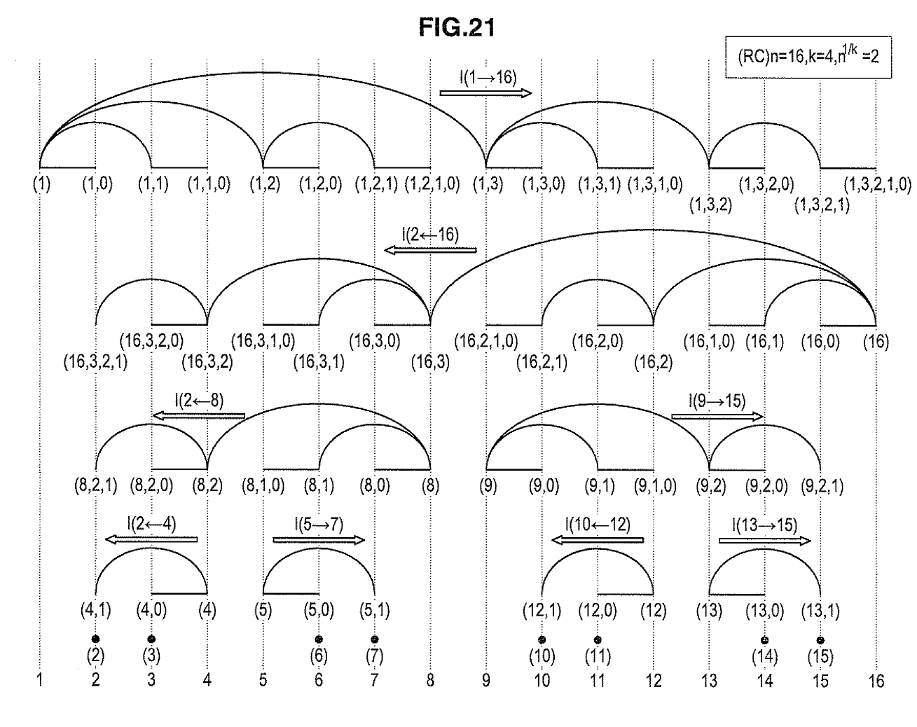

The function configuration of the key distribution server 202 according to the present embodiment has been described. The directed graph I of the RC system can be generated from the above configuration. Examples of the directed graph I are shown in FIGS. 18 and 19. FIG. 18 is an explanatory view showing the directed graph I generated under the condition of number of contractors n=64 and the parameter k=6. FIG. 19 is an explanatory view showing the directed graph I generated under the condition of number of contractors n=64 and the parameter k=3. A case of number of contractors n=16 and the parameter k=4 is shown in FIG. 21.

As described above, the present embodiment is a technique in which the underlying technique of the first embodiment is replaced to the RC system. Therefore, the RC system can be extended to the public key encryption system by applying the technique according to the information processing device 150 of the first embodiment to the directed graph I of the RC system. The detailed description on the function configuration of the information processing device 150 according to the present embodiment will be omitted, and only the flow of the key setting process and the flow of the key distribution process according to the present embodiment will be briefly described. When the technique according to the information processing device 150 of the first embodiment is applied to the directed graph I of the RC system, the directed graph I as shown in FIG. 21 and the identifier corresponding to each node are set.

### [Flow of Key Setting Process]

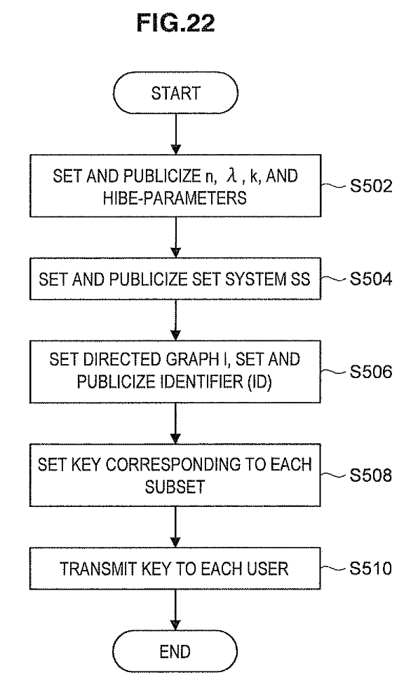

The flow of the key setting process according to the present embodiment will be briefly described with reference to FIG. 22. FIG. 22 is an explanatory view showing the flow of the key setting process according to the present embodiment.

As shown in FIG. 22, n, X, k, and HIBE-params are set and publicized as public parameters (S502). The set system SS is then set and publicized (S504). The directed graph I is set (generated), and the identifier is set and publicized to each node of the directed graph I (S506). The key corresponding to each subset is set (derived) (S508). A predetermined key is provided (transmitted) to the terminal device 122 of each user (S510). The key setting process is executed according to the above flow.

### [Flow of Key Distribution Process]

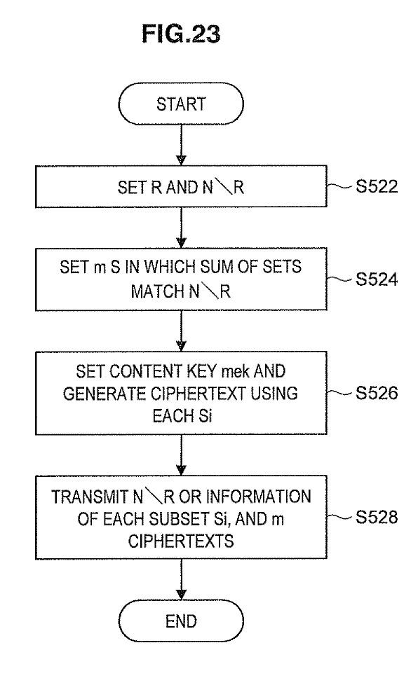

The flow of the key distribution process according to the present embodiment will be briefly described with reference to FIG. 23. FIG. 23 is an explanatory view showing the flow of the key distribution process according to the present embodiment.

As shown in FIG. 23, the set R of the eliminated contractor and the set N\R of the permitted contractor are set (S522). Then, m subsets S in which the sum of sets match the set N\R of the permitted contractor match are set (S524). The content key mek is set, and the cipher text is generated for each set subset Si (S526). The set N\R of the permitted contractor or the information of each subset Si, and m cipher texts are transmitted (S528). The key distribution process is executed according to the above flow.

### Third Embodiment

A specific system related to a configuration and a key distribution of a key distribution system 100 according to a third embodiment of the present invention will be described in detail with reference to the drawings. Same reference numerals are denoted for the components substantially the same as the key distribution system 100 according to the first embodiment to omit redundant explanation, and the different components will be described in detail.

### Features of Third Embodiment

The difference between the third embodiment and the first embodiment of the present invention will be briefly described. First, the largest difference between the first embodiment and the present embodiment lies in the difference in the underlying key distribution system. The first embodiment is based on the AI system, whereas the present embodiment is applied to the RS system. The issues of the AI system have been described in the description related to the second embodiment, where the RS system provides a solution to one of the problems that the number of keys to be held by each contractor is large. The RS system has a feature in the configuration of replacing the length of the directional branch configuring the directed graph to be short under the condition that the number of directional branches of the longest directional path in which the number of directional branches configuring the directional path becomes a maximum is not exceeded in the directed graph H of the AI system. That is, the RS system reduces the number of keys to be held by each contractor while maintaining the amount of calculation to about the same as the AI system.

### [Configuration of Key Distribution System 100]

The configuration of the key distribution system 100 according to the present embodiment will be described. The basic system configuration is substantially the same as the configuration of the first embodiment shown in FIG. 1, and thus the detailed description will be omitted. The hardware configuration of a key distribution server 302 in the key distribution system 100 according to the present embodiment is also substantially the same as the hardware configuration of the key distribution server 102 shown in FIG. 2, and thus the detailed description will be omitted.

### [Function Configuration of Key Distribution Server 302]

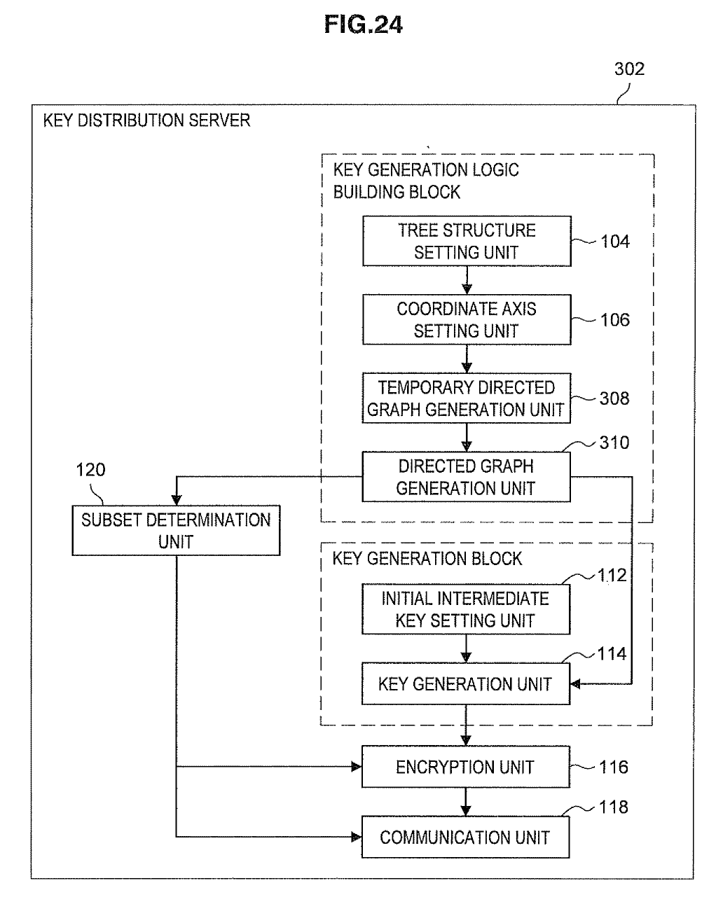

The function configuration of the key distribution server 302 according to the present embodiment will be described with reference to FIG. 24. FIG. 24 is an explanatory view showing the function configuration of the key distribution server 302 according to the present embodiment.

As shown in FIG. 24, the key distribution server 302 is mainly configured with the tree structure setting unit 104, a coordinate axis setting unit 106, a temporary directed graph generation unit 308, a directed graph generation unit 310, the initial intermediate key setting unit 112, the key generation unit 114, the encryption unit 116, the communication unit 118, and the subset determination unit 120. The distinguishing configuration of the present embodiment is mainly the temporary directed graph generation unit 308 and the directed graph generation unit 310, and other components substantially the same as the components of the key distribution server 102 according to the first embodiment. Therefore, only the function configuration of the temporary directed graph generation unit 308 and the directed graph generation unit 310 will be described in detail.

### (Temporary Directed Graph Generation Unit 308)

First, the function configuration of the temporary directed graph generation unit 308 will be described. The temporary directed graph generation unit 308 has a function configuration substantially the same as the directed graph generation unit 110 according to the first embodiment and has a function of generating a temporary directed graph I′ having the same shape as the directed graph H of the AI system. For instance, if n=64 and parameter k=6, the temporary directed graph I′ matches the directed graph H shown in FIG. 5.

### (Directed Graph Generation Unit 310)

The directed graph generation unit 310 will now be described. The directed graph generation unit 310 has a function of generating the directed graph I by replacing one part of a plurality of directional branches configuring the temporary directed graph I′. First, the directed graph generation unit 310 selects the directional path in which the number of directional branches configuring the same is a maximum from the directional paths contained in the temporary directed graph I′. Such directional path is referred to as longest directional path LP (Longest Path). The directed graph generation unit 310 generates the directed graph I by replacing the directional path of one part contained in the temporary directed graph I′ with the directional path configured by a chain of plurality of directional branches of shorter length under the condition that the number of direction branches of all the directional paths does not exceed the number of directional branches of the longest directional path LP.

### (Generation Method of Directed Graph I)

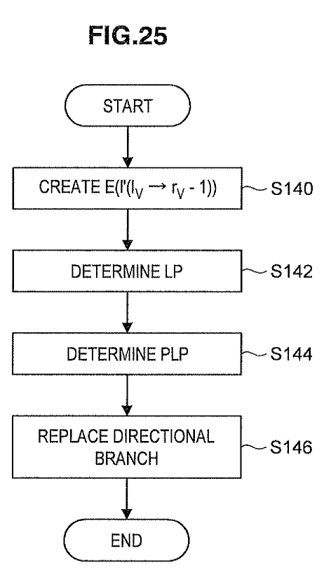

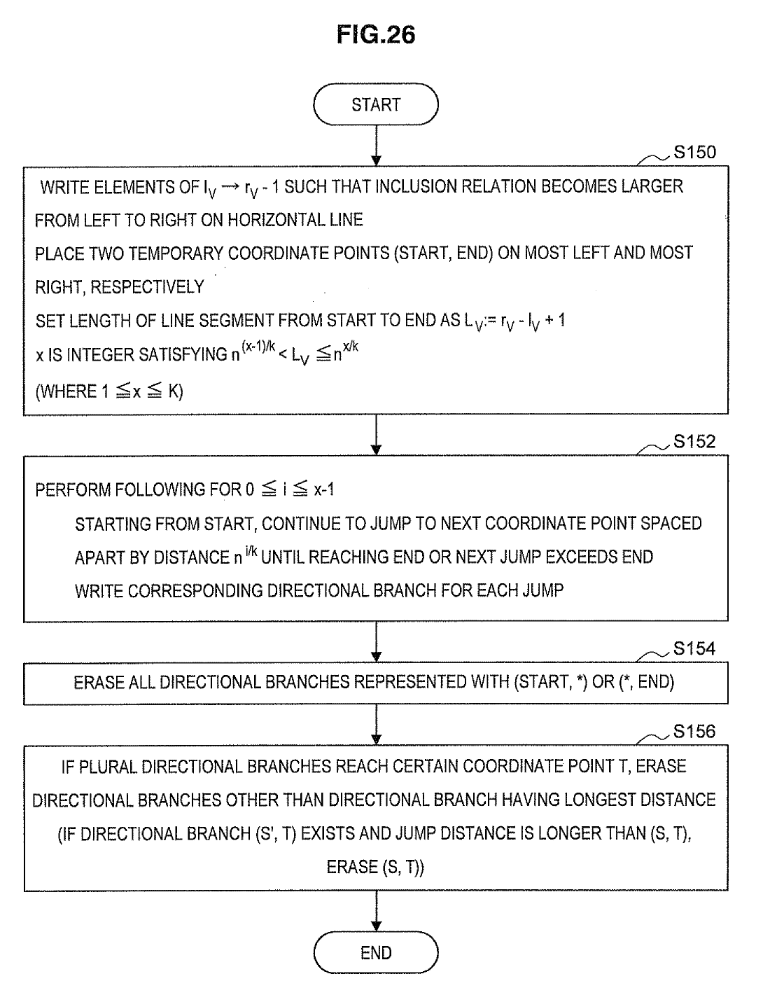

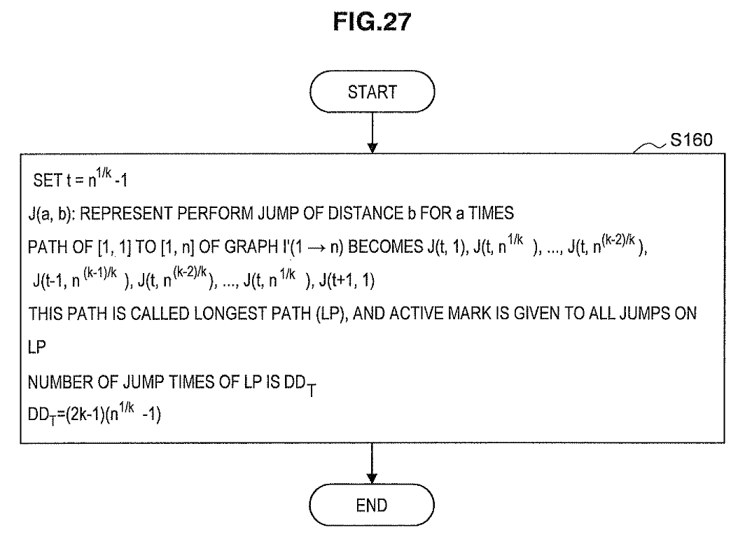

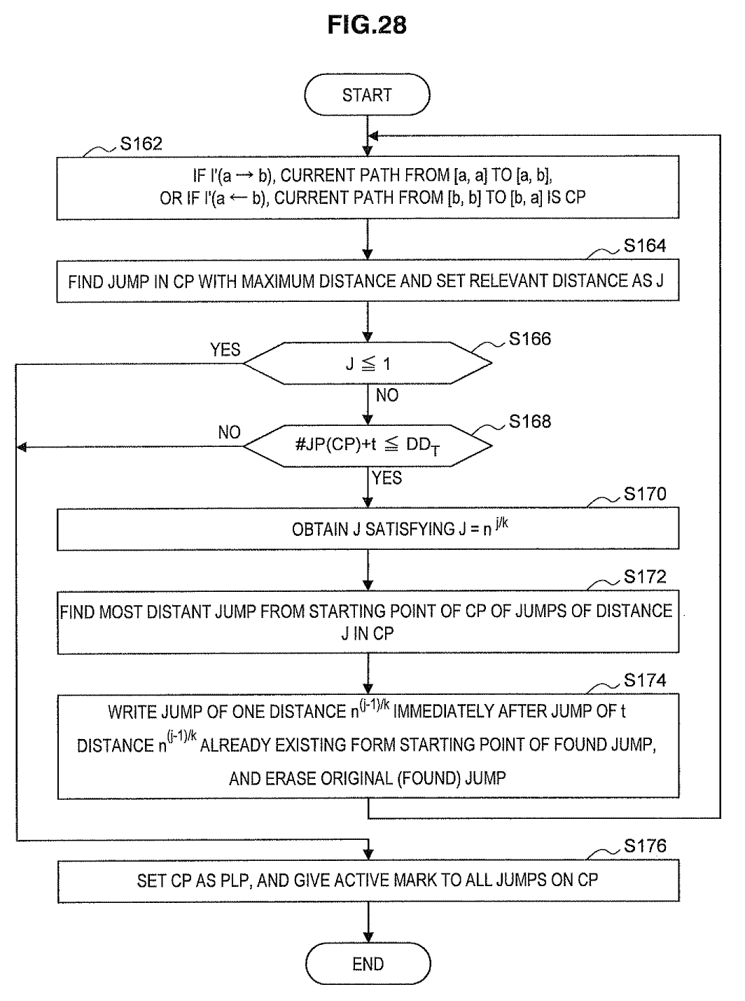

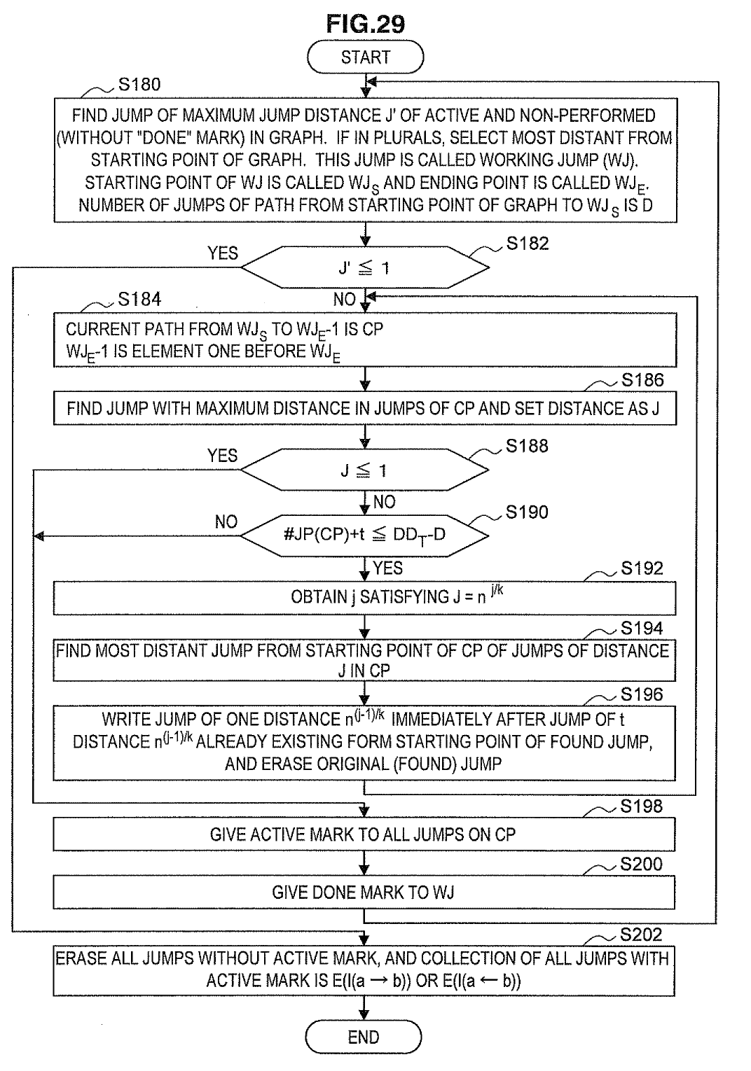

First, a generation method of the directed graph I will be described with reference to FIGS. 25 to 29. FIG. 25 is an explanatory view showing an overall flow of the process for generating the directed graph I. FIG. 26 is an explanatory view showing a generation process of the temporary directed graph I′. FIG. 27 is an explanatory view showing a flow of process for extracting the longest directional path LP. FIG. 28 is an explanatory view showing a flow of process for extracting the directional path PLP of longest length (Partially Longest Path) from the directional paths other than the longest directional path LP. FIG. 29 is an explanatory view showing a process of replacing the directional path of the temporary directed graph I′ with the directional path configured by a set of shorter directional branches.

As shown in FIG. 25, first the temporary directed graph I′ is generated by the temporary directed graph generation unit 308 (S140). The longest directional path LP is extracted from the directional paths forming the temporary directed graph I′ (S142). The directional path PLP of longest length is extracted from the directional paths other than the longest directional path LP of the temporary directed graph I′ (S144). The directional path PLP of longest length may be extracted for the temporary directed graph I′ corresponding to each subset. The directional branch configuring the directional path of the temporary directed graph I′ is then replaced with the shorter directional branch (S146). In this case, the directional branch is replaced such that the number of directional branches of all the directional paths does not exceed the number of directional branches of the longest directional path LP. That is, the worst value of the amount of calculation for generating the key does not increase from the AI system even if such replacement process is executed.

Each step shown in FIG. 25 will be more specifically described below.

### (Details of S140)

First, the generation process of the temporary directed graph I′ will be described with reference to FIG. 26. FIG. 26 is an explanatory view showing a generation process of the temporary directed graph I′ (lᵥ→rᵥ−1).

First, the elements of the set (lᵥ→rᵥ−1) are lined so that the inclusion relation becomes larger from the left to the right on the horizontal line. The left most coordinate point is the starting point. The two temporary coordinate points are arranged on the right of the right most coordinate point. One coordinate point (Start, End) is arranged on the right side and the left side of the right most coordinate point. The length from the left most coordinate point Start to the right most coordinate point End then becomes Lᵥ=rᵥ−lᵥ+1. Furthermore, an integer x (1≦x≦k) satisfying n^{(x-1)/k}<Lᵥ≦n^{x/k} is calculated (S150). This process is mainly executed by the coordinate axis setting unit 106.

The following operation is performed while moving the counter i from 0 to x−1. Starting from the temporary coordinate point Start, jump is continuously made from such coordinate point to the coordinate point spaced apart by n^{i/k} until reaching the temporary coordinate point End or when the next jump exceeds the temporary coordinate point End. The directional branch corresponding to each jump is then generated (S152). The directional branches reaching the temporary coordinate point are all erased (S154). If the directional branch reaching a certain coordinate point T is in plurals, the directional branches other than the directional branch having the longest jump distance are erased (S156). This process is mainly executed by the temporary directed graph generation unit 308.

### (Details of S142)

The step of extracting the longest directional path LP (S160) will be described in detail below with reference to FIG. 27. The following two notations are introduced.

DD_{T}: Number of directional branches of the longest directional path LP

J(a, b): a directional branches of length b exist continuously

First, t=n^{1/k}−1. The directional path P([1, 1], [1, n]) from the coordinate point [1, 1] to the coordinate point [1, n] of the temporary directed graph I′(1→n) is then considered. The directional path P([1, 1], [1, n]) is expressed as J(t, 1), J(t, n^{l/k}), . . . , J(t, n^{(k-2)/k}), J(t−1, n^{(k-1)/k}), J(t, n^{(k-2)/k}), . . . , J(t, n^{l/k}), J(t+1, 1). This directional path is referred to as longest directional path LP. The number of directional branch DD_{T} of the longest directional path LP becomes DD_{T}=(2k−1)*(n^{l/k}−1). An active mark is set on all the directional branches configuring the longest directional path LP (S160).

### (Details of S144)

The process (S162 to S176) of extracting the directional path PLP of longest length for the temporary directed graph I′ corresponding to all the subsets other than the temporary directed graph I′ including the longest directional path LP will be described below with reference to FIG. 28. The following two notations are introduced.

CP(Current Path): Directional path in reference (current path)

#JP(CP): Number of directional branches of current path

A current path CP from the starting point to the ending point of the directed graph I′ is determined. If the current path is included in the directed graph I′(a→b), the directional path ([a, a], [a, b]) is the current path CP, and if included in the directed graph I′(a←b), the directional path P([b, b], [b, a]) is the current path CP (S162). The longest directional branch of the directional branches configuring the current path CP is selected, and the length thereof is set as J (S164). Whether or not J≦1 is determined (S166).

If J≦1, the current path CP is determined as the directional path PLP of longest length, and the active mark is set to all the directional branches included in the current path CP (S176). If J>1, whether or not #JP(CP)+t≦DD_{T} is determined (S168). If not #JP(CP)+t≦DD_{T}, the current path CP is determined as the directional path PLP, and the active mark is set to all the directional branches included in the current path (S176). If #JP(CP)+t≦DD_{T}, a natural number j satisfying J=n^{j/k} is calculated (S170).

The directional branch most distant from the stating point of the current path CP in the directional branches having length J included in the current path CP is extracted (S172). One directional branch having a length of n^{(j-1)/k} is added immediately after the t directional branches having length n^{(j-1)/k} extending from the starting point of the directional branch extracted in step S172, and the directional branch extracted in step S172 is removed (S174), and the process returns to step S162 to repeatedly execute the above processes.

A loop process between step S162 and step S174 is terminated when the directional path from the starting point to the ending point of the directed graph I′ is configured by directional branches all having length one, or when the number of directional branches configuring the directional path exceeds DD_{T} by executing the replacement of greater directional branches.

### (Details of S146)

The process (S180 to S202) of replacing the directional branch included in the temporary directed graph I′ with the short directional branch will be described in detail below with reference to FIG. 29.

First, the directional branch in which the length J′ is the longest is extracted from the active and non-performed (without done mark) directional branch in the graph. If the maximum directional branch exists in plurals, the directional branch most distant from the starting point of the temporary directed graph I′ is selected (S180). The selected directional branch is referred to as WJ (Working Jump). The starting point of the directional branch WJ is WJ_{S} and the ending point is WJ_{E}. The number of directional branches included in the directional path from the starting point of the temporary directed graph I′ to WJ_{S} is noted as D.

Whether the length J′ of the directional branch is J′≦1 is determined (S182). If J′≦1, all the directional branches without the active mark are erased, and a collection of all the directional branches with the active mark are set as E(I(a→b)) or E(I(a←b)) (S202). On the other hand, if not J′≦1, the directional path from WJ_{S} to WJ_{E}−1 is set as the current path CP (S184). Here, WJ_{E}−1 represents the element one before WJ_{E}.

The longest directional branch is selected from the directional branches included in the current path CP, and the length thereof is set as J (S186). Whether or not the length J of the directional branch is J≦1 is determined (S188). If J≦1, the active mark is given to all the directional branches included in the current path CP (S198). The done mark is given to the WJ (S200), and the process returns to the process of step S180. If not J≦1, whether or not #JP(CP)+t≦DD_{T}-D is determined (S190). If not #JP(CP)+t≦DD_{T}-D, the process returns to step S180 after the processes of steps S198 and S200. If #JP(CP)+t≦DD_{T}-D, j satisfying J=n^{j/k} is calculated (S192).

If the directional branch having length J included in the current path CP exists in plural, the directional branch at a position most distant from the starting point of the current path CP is extracted (S194). One directional branch having a length of n(j−1)/k is added immediately after the n^{l/k}−1 directional branches having length n^{(j-1)/k} extending from the starting point of the directional branch extracted in step S194, and the directional branch extracted in step S194 is erased (S196). The process returns to the process of step S184.

A loop process between step S184 and step S196 is terminated when the directional path from the WJ_{S} to the WJ_{E}−1 is configured by directional branches all having length one, or when the number of directional branches included in the directional path from the WJ_{S} to the WJ_{E}−1 exceeds DD_{T}-D by replacing greater directional branches. The loop process between steps S180 and S200 is terminated at the point the directional branch not set with done and having a length of greater than or equal to two are all erased from the directional branches included in the temporary directed graph I′.

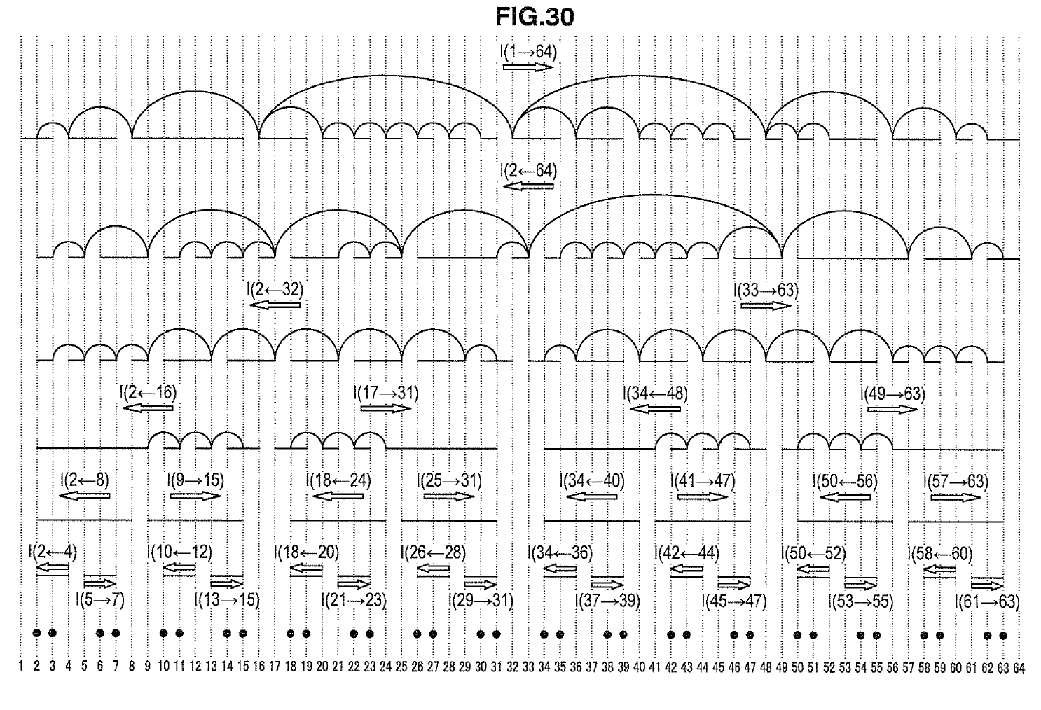

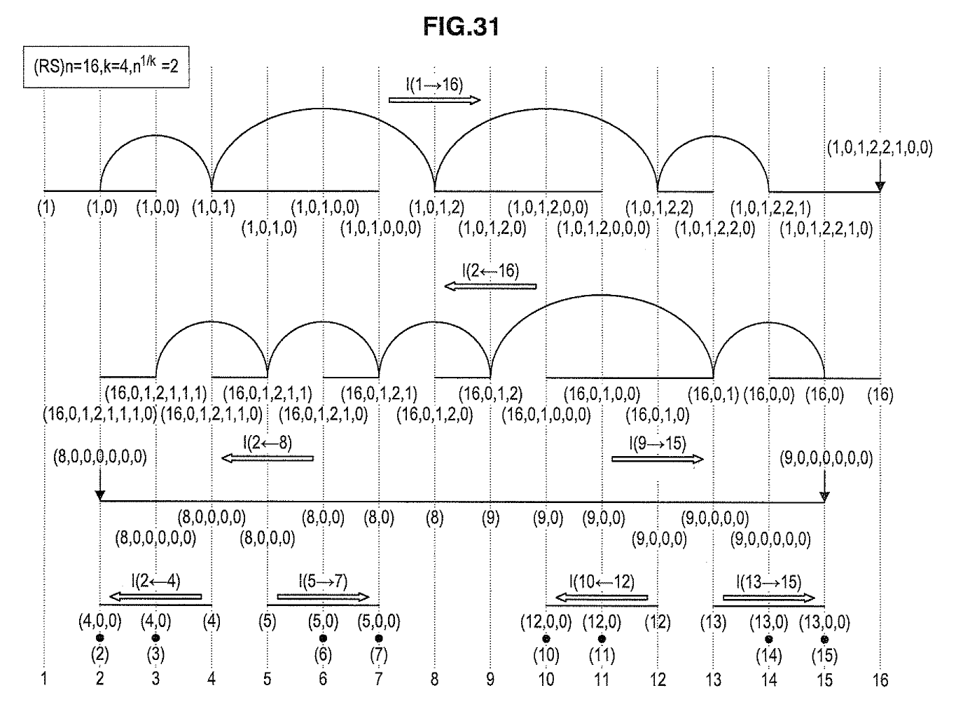

The generation method of the directed graph I according to the present embodiment has been described. The directed graph I as shown in FIG. 30 is generated by using the above method. In the case of number of contractors n=16 and parameter k=4, the directed graph I as shown in FIG. 31 is generated.

As described above, the present embodiment is a technique in which the underlying technique of the first embodiment is replaced to the RS system. Therefore, the RS system can be extended to the public key encryption system by applying the technique according to the information processing device 150 of the first embodiment to the directed graph I of the RS system. The detailed description on the function configuration of the information processing device 150 according to the present embodiment will be omitted, and only the flow of the key setting process and the flow of the key distribution process according to the present embodiment will be briefly described. When the technique according to the information processing device 150 of the first embodiment is applied to the directed graph I of the RS system, the directed graph I as shown in FIG. 31 and the identifier corresponding to each node are set.

### [Flow of Key Setting Process]

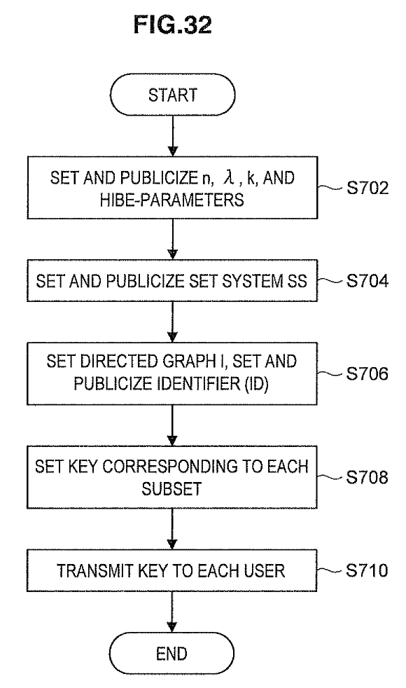

The flow of the key setting process according to the present embodiment will be briefly described with reference to FIG. 32. FIG. 32 is an explanatory view showing the flow of the key setting process according to the present embodiment.

As shown in FIG. 32, n, λ, k, and HIBE-params are set and publicized as public parameters (S702). The set system SS is then set and publicized (S704). The directed graph I is set (generated), and the identifier is set and publicized to each node of the directed graph I (S706). The key corresponding to each subset is set (derived) (S708). A predetermined key is provided (transmitted) to the terminal device 122 of each user (S710). The key setting process is executed according to the above flow.

### [Flow of Key Distribution Process]

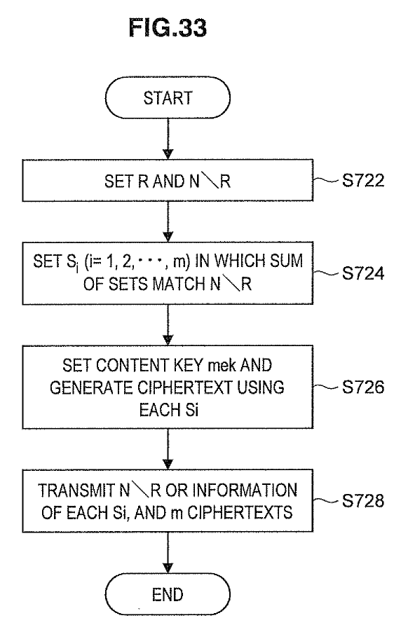

The flow of the key distribution process according to the present embodiment will be briefly described with reference to FIG. 33. FIG. 33 is an explanatory view showing the flow of the key distribution process according to the present embodiment.

As shown in FIG. 33, the set R of the eliminated contractor and the set N\R of the permitted contractor are set (S722). Then, m subsets S in which the sum of sets match the set N\R of the permitted contractor match are set (S724). The content key mek is set, and the cipher text is generated for each set subset Si (S726). The set N\R of the permitted contractor or the information of each subset Si, and m cipher texts are transmitted (S728). The key distribution process is executed according to the above flow.

### Fourth Embodiment

A specific system related to a configuration and a key distribution of a key distribution system 100 according to a fourth embodiment of the present invention will be described in detail with reference to the drawings. Same reference numerals are denoted for the components substantially the same as the key distribution system 100 according to the first embodiment to omit redundant explanation, and the different components will be described in detail.

### Features of Fourth Embodiment

The difference between the fourth embodiment and the first embodiment of the present invention will be briefly described. First, the largest difference between the first embodiment and the present embodiment lies in the difference in the underlying key distribution system. The first embodiment is based on the AI system, whereas the present embodiment is applied to the RCS system. Similar to the RC system, the RCS system has a feature in the configuration of replacing the length of the directional branch configuring the directed graph to be short under the condition that the number of directional branches of the longest directional path in which the number of directional branches configuring the directional path becomes a maximum is not exceeded in the temporary directed graph after generating the temporary directed graph using longer directional branches. That is, the RCS system reduces the amount of calculation for key generation and the number of keys to be held by each contractor compared to the AI system.

### [Configuration of Key Distribution System 100]

The configuration of the key distribution system 100 according to the present embodiment will be described. The basic system configuration is substantially the same as the configuration of the first embodiment shown in FIG. 1, and thus the detailed description will be omitted. The hardware configuration of a key distribution server 402 in the key distribution system 100 according to the present embodiment is also substantially the same as the hardware configuration of the key distribution server 102 shown in FIG. 2, and thus the detailed description will be omitted.

### [Function Configuration of Key Distribution Server 402]

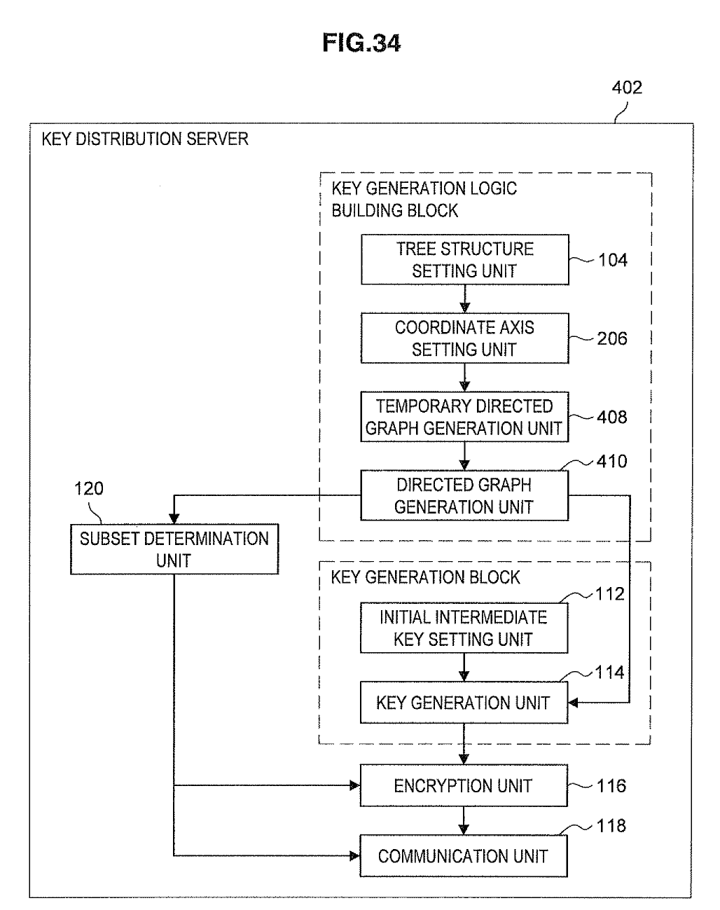

The function configuration of the key distribution server 402 according to the present embodiment will be described with reference to FIG. 34. FIG. 34 is an explanatory view showing the function configuration of the key distribution server 402 according to the present embodiment.

As shown in FIG. 34, the key distribution server 402 is mainly configured with the tree structure setting unit 104, a coordinate axis setting unit 306, a temporary directed graph generation unit 408, a directed graph generation unit 410, the initial intermediate key setting unit 112, the key generation unit 114, the encryption unit 116, the communication unit 118, and the subset determination unit 120. The distinguishing configuration of the present embodiment is mainly the temporary directed graph generation unit 408 and the directed graph generation unit 410, and other components substantially the same as the components of the key distribution server 102 according to the first or the second embodiment. Therefore, only the function configuration of the temporary directed graph generation unit 408 and the directed graph generation unit 410 will be described in detail.

### (Temporary Directed Graph Generation Unit 408)

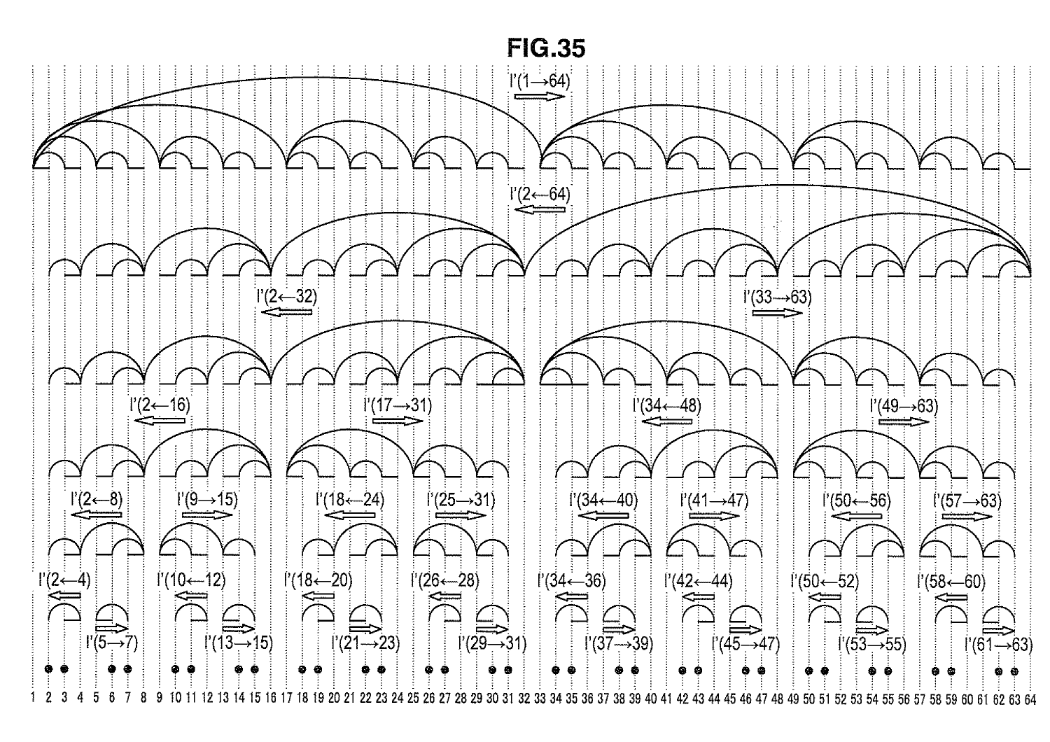

First, the function configuration of the temporary directed graph generation unit 408 will be described. The temporary directed graph generation unit 408 has a function configuration substantially the same as the directed graph generation unit 210 according to the second embodiment and has a function of generating a temporary directed graph I′ having the same shape as the directed graph I of the RC system. For instance, if n=64 and parameter k=6, the temporary directed graph I′ shown in FIG. 35 matches the directed graph I shown in FIG. 18.

### (Directed Graph Generation Unit 410)

The directed graph generation unit 410 will now be described. The directed graph generation unit 410 has a function of generating the directed graph I by replacing one part of a plurality of directional branches configuring the temporary directed graph I′. First, the directed graph generation unit 410 selects the directional path in which the number of directional branches configuring the same is a maximum from the directional paths contained in the temporary directed graph I′. Such directional path is referred to as longest directional path LP (Longest Path). The directed graph generation unit 410 generates the directed graph I by replacing the directional path of one part contained in the temporary directed graph I′ with the directional path configured by a chain of plurality of directional branches of shorter length under the condition that the number of direction branches of all the directional paths does not exceed the number of directional branches of the longest directional path LP.

### (Generation Method of Directed Graph I)

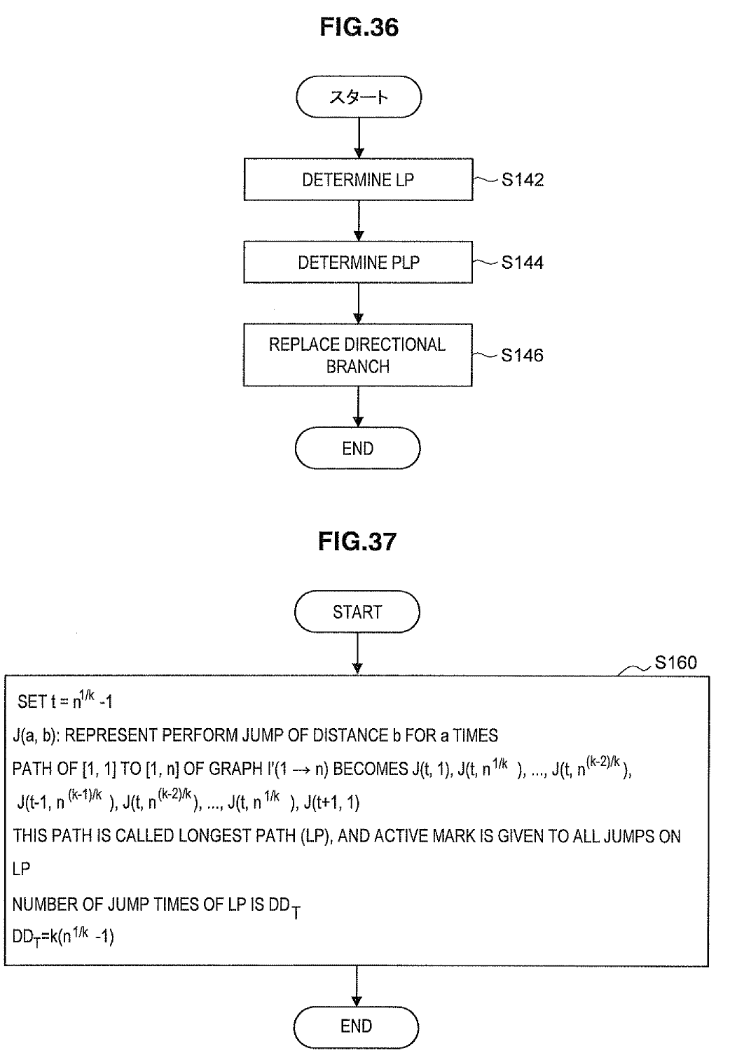

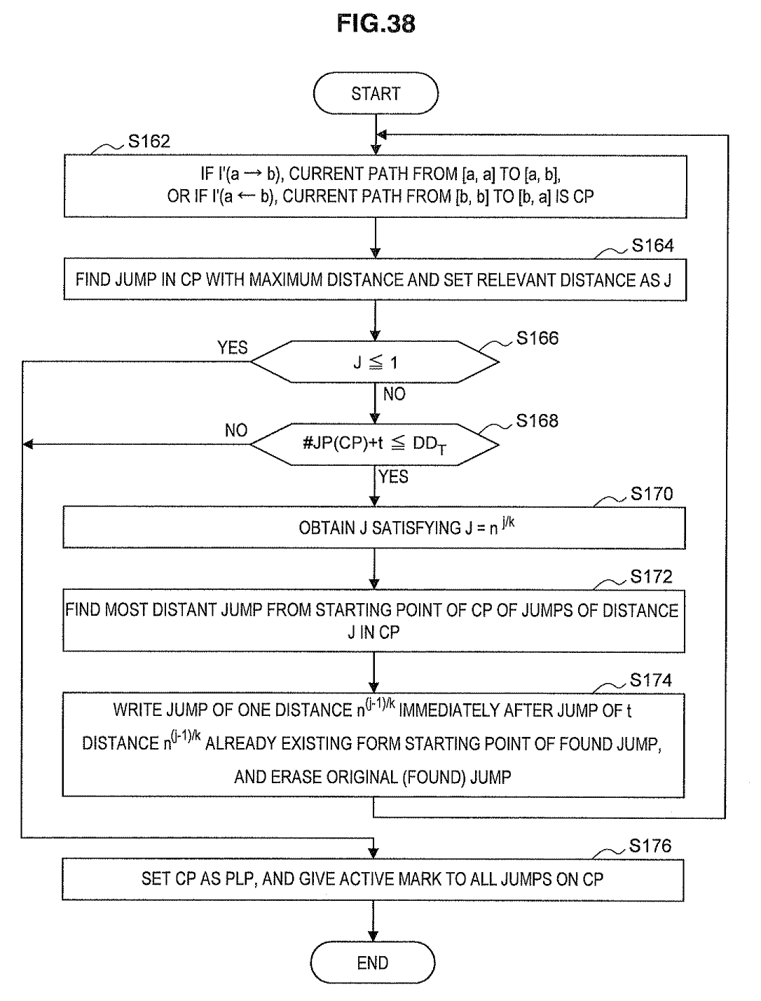

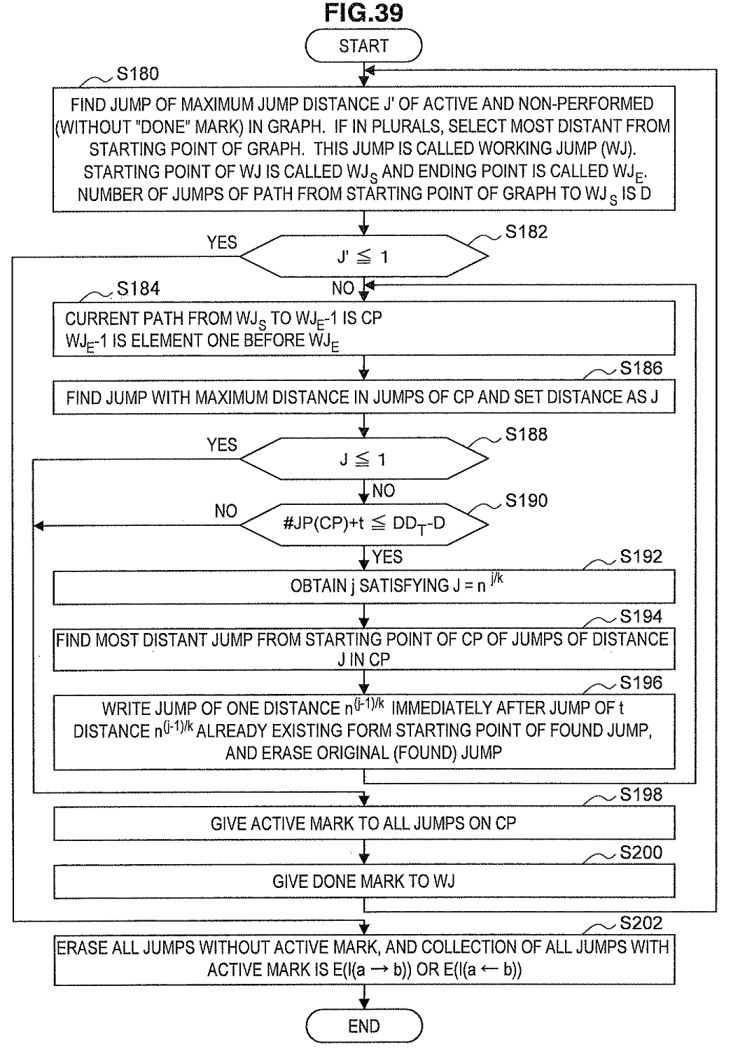

First, a generation method of the directed graph I will be described with reference to FIGS. 36 to 39. FIG. 36 is an explanatory view showing an overall flow of the process for generating the directed graph I. FIG. 37 is an explanatory view showing a flow of process for extracting the longest directional path LP. FIG. 38 is an explanatory view showing a flow of process for extracting the directional path PLP of longest length (Partially Longest Path) from the directional paths other than the longest directional path LP. FIG. 39 is an explanatory view showing a process of replacing the directional path of the temporary directed graph I′ with the directional path configured by a set of shorter directional branches.

As shown in FIG. 36, first the longest directional path LP is extracted from the directional paths forming the temporary directed graph I′ (S142). The directional path PLP of longest length is extracted from the directional paths other than the longest directional path LP of the temporary directed graph I′ (S144). The directional path PLP of longest length may be extracted for the temporary directed graph I′ corresponding to each subset. The directional branch configuring the directional path of the temporary directed graph I′ is then replaced with the shorter directional branch (S146). In this case, the directional branch is replaced such that the number of directional branches of all the directional paths does not exceed the number of directional branches of the longest directional path LP. That is, the worst value of the amount of calculation for generating the key does not increase from the RC system even if such replacement process is executed. Each step shown in FIG. 36 will be more specifically described below.

### (Details of S142)

The step of extracting the longest directional path LP (S160) will be described in detail below with reference to FIG. 37. The following two notations are introduced.

DD_{T}: Number of directional branches of the longest directional path LP

J(a, b): a directional branches of length b exist continuously

First, t=n^{l/k-1}. The directional path P([1, 1], [1, n]) from the coordinate point [1, 1] to the coordinate point [1, n] of the temporary directed graph I′(1→n) is then considered. The directional path P([1, 1], [1, n]) is expressed as J(t, n^{(k-1)/k}), J(t, n^{(k-2)/k}), . . . , J(t, n^{1/k}), J(t, n^{0/k}). This directional path is referred to as longest directional path LP. The number of directional branch DD_{T} of the longest directional path LP becomes DD_{T}=k*(n^{1/k}−1). An active mark is set on all the directional branches configuring the longest directional path LP (S160).

### (Details of S144)

The process (S162 to S176) of extracting the directional path PLP of longest length for the temporary directed graph I′ corresponding to all the subsets other than the temporary directed graph I′ including the longest directional path LP will be described below with reference to FIG. 38. The following two notations are introduced.

CP(Current Path): Directional path in reference (current path)

#JP(CP): Number of directional branches of current path

A current path CP from the starting point to the ending point of the directed graph I′ is determined. If the current path is included in the directed graph I′(a→b), the directional path ([a, a], [a, b]) is the current path CP, and if included in the directed graph I′(a←b), the directional path P([b, b], [b, a]) is the current path CP (S162). The longest directional branch of the directional branches configuring the current path CP is selected, and the length thereof is set as J (S164). Whether or not J≦1 is determined (S166).

If J≦1, the current path CP is determined as the directional path PLP of longest length, and the active mark is set to all the directional branches included in the current path CP (S176). If J>1, whether or not #JP(CP)+t≦DD_{T} is determined (S168). If not #JP(CP)+t≦DD_{T}, the current path CP is determined as the directional path PLP, and the active mark is set to all the directional branches included in the current path (S176). If #JP(CP)+t≦DD_{T}, a natural number j satisfying J=n^{j/k} is calculated (S170).

The directional branch most distant from the stating point of the current path CP in the directional branches having length J included in the current path CP is extracted (S172). One directional branch having a length of n^{(j-1)/k} is added immediately after the t directional branches having length n^{(j-1)/k} extending from the starting point of the directional branch extracted in step S172, and the directional branch extracted in step S172 is removed (S174), and the process returns to step S162 to repeatedly execute the above processes.

A loop process between step S162 and step S174 is terminated when the directional path from the starting point to the ending point of the directed graph I′ is configured by directional branches all having length one, or when the number of directional branches configuring the directional path exceeds DD_{T} by executing the replacement of greater directional branches.

### (Details of S146)

The process (S180 to S202) of replacing the directional branch included in the temporary directed graph I′ with the short directional branch will be described in detail below with reference to FIG. 39.

First, the directional branch in which the length J′ is the longest is extracted from the active and non-performed (without done mark) directional branch in the graph. If the maximum directional branch exists in plurals, the directional branch most distant from the starting point of the temporary directed graph I′ is selected (S180). The selected directional branch is referred to as WJ (Working Jump). The starting point of the directional branch WJ is WJ_{S} and the ending point is WJ_{E}. The number of directional branches included in the directional path from the starting point of the temporary directed graph I′ to WJ_{S} is noted as D.

Whether the length J′ of the directional branch is J′≦1 is determined (S182). If J′≦1, all the directional branches without the active mark are erased, and a collection of all the directional branches with the active mark are set as E(I(a→b)) or E(I(a←b)) (S202). On the other hand, if not J′≦1, the directional path from WJ_{S} to WJ_{E}−1 is set as the current path CP (S184). Here, WJ_{E}−1 represents the element one before WJ_{E}.

The longest directional branch is selected from the directional branches included in the current path CP, and the length thereof is set as J (S186). Whether or not the length J of the directional branch is J≦1 is determined (S188). If J≦1, the active mark is given to all the directional branches included in the current path CP (S198). The done mark is given to the WJ (S200), and the process returns to the process of step S180. If not J≦1, whether or not #JP(CP)+t≦DD_{T}-D is determined (S190). If not #JP(CP)+t≦DD_{T}-D, the process returns to step S180 after the processes of steps S198 and S200. If #JP(CP)+t≦DD_{T}-D, j satisfying J=n^{j/k} is calculated (S192).

If the directional branch having length J included in the current path CP exists in plural, the directional branch at a position most distant from the starting point of the current path CP is extracted (S194). One directional branch having a length of n^{(j-1)/k} is added immediately after the n^{l/k}−1 directional branches having length n^{(j-1)/k} extending from the starting point of the directional branch extracted in step S194, and the directional branch extracted in step S194 is erased (S196). The process returns to the process of step S184.

A loop process between step S184 and step S196 is terminated when the directional path from the WJ_{S} to the WJ_{E}−1 is configured by directional branches all having length one, or when the number of directional branches included in the directional path from the WJ_{S} to the WJ_{E}−1 exceeds DD_{T}-D by replacing greater directional branches. The loop process between steps S180 and S200 is terminated at the point the directional branch not set with done and having a length of greater than or equal to two are all erased from the directional branches included in the temporary directed graph I′.

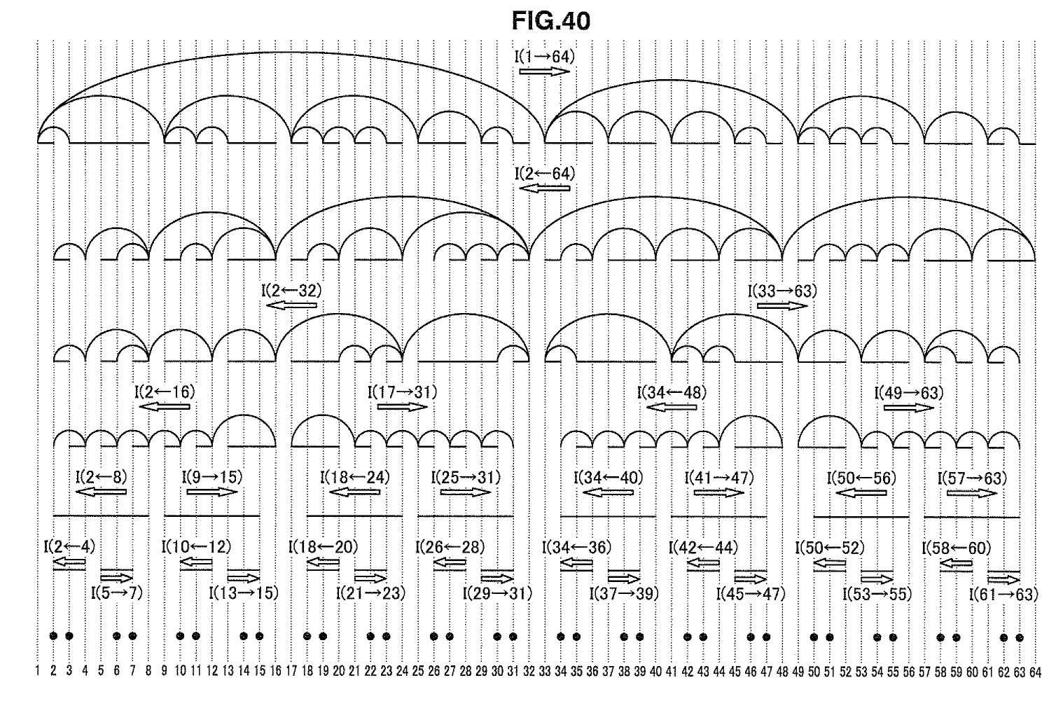

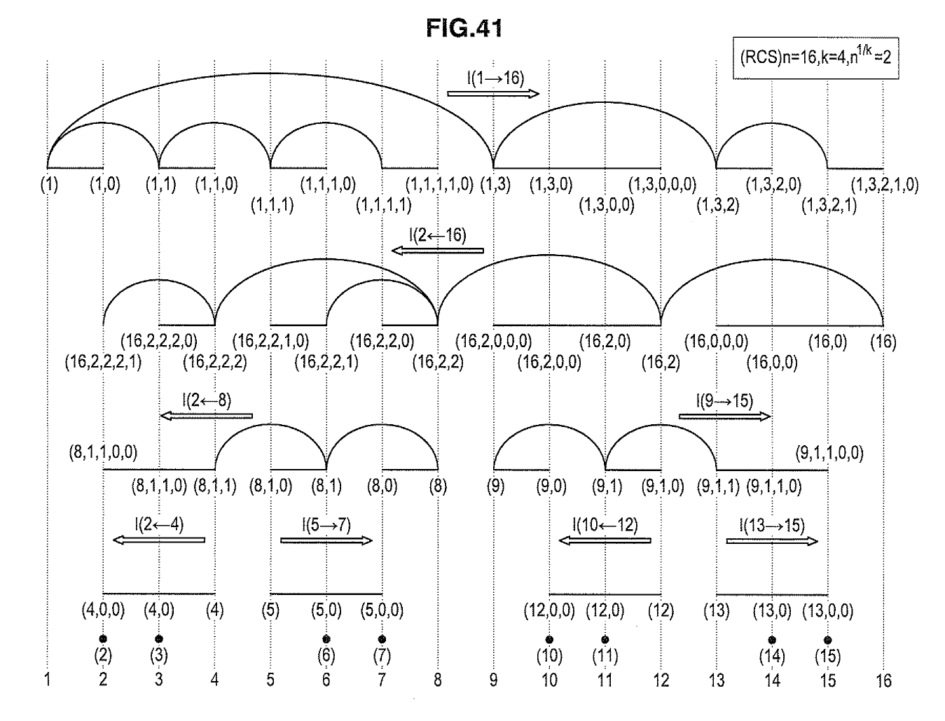

The generation method of the directed graph I according to the present embodiment has been described. If number of contractors n=64 and parameter k=6, the directed graph I according to the present embodiment is as shown in FIG. 40. In the case of number of contractors n=16 and parameter k=4, the directed graph I according to the present embodiment is as shown in FIG. 41.

As described above, the present embodiment is a technique in which the underlying technique of the first embodiment is replaced to the RCS system. Therefore, the RCS system can be extended to the public key encryption system by applying the technique according to the information processing device 150 of the first embodiment to the directed graph I of the RCS system. The detailed description on the function configuration of the information processing device 150 according to the present embodiment will be omitted, and only the flow of the key setting process and the flow of the key distribution process according to the present embodiment will be briefly described. When the technique according to the information processing device 150 of the first embodiment is applied to the directed graph I of the RCS system, the directed graph I as shown in FIG. 41 and the identifier corresponding to each node are set.

### [Flow of Key Setting Process]

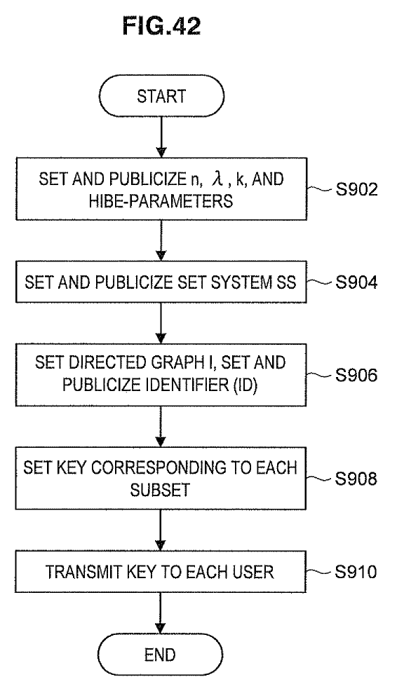

The flow of the key setting process according to the present embodiment will be briefly described with reference to FIG. 42. FIG. 42 is an explanatory view showing the flow of the key setting process according to the present embodiment.

As shown in FIG. 42, n, λ, k, and HIBE-params are set and publicized as public parameters (S902). The set system SS is then set and publicized (S904). The directed graph I is set (generated), and the identifier is set and publicized to each node of the directed graph I (S906). The key corresponding to each subset is set (derived) (S908). A predetermined key is provided (transmitted) to the terminal device 122 of each user (S910). The key setting process is executed according to the above flow.

### [Flow of Key Distribution Process]

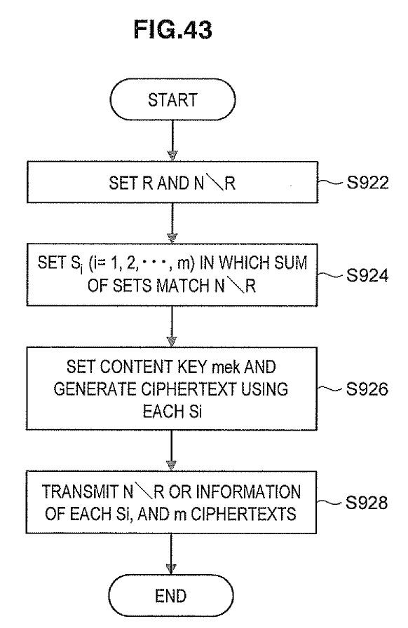

The flow of the key distribution process according to the present embodiment will be briefly described with reference to FIG. 43. FIG. 43 is an explanatory view showing the flow of the key distribution process according to the present embodiment.

As shown in FIG. 43, the set R of the eliminated contractor and the set N\R of the permitted contractor are set (S922). Then, m subsets S in which the sum of sets match the set N\R of the permitted contractor match are set (S924). The content key mek is set, and the cipher text is generated for each set subset Si (S926). The set N\R of the permitted contractor or the information of each subset Si, and m cipher texts are transmitted (S928). The key distribution process is executed according to the above flow.

As described above, each of the above embodiments can extend to the public key encryption system by setting the identifier based on the common algorithm even if the directed graph of the underlying broadcast encryption system or the key deriving rule corresponding thereto differs. The system can be extended to the public key encryption system by devising the identifier setting method, and thus the properties of the underlying technique can be carried on, and the effects of the RC system having more satisfactory properties than the AI system, the RS system, the RCS system, and the like can be inherited. If a more effective new system is developed, a more effective public key encryption system can be realized by applying the technique according to the embodiment of the present invention.

It should be understood by those skilled in the art that various modifications, combinations, sub-combinations and alterations may occur depending on design and other factors insofar as they are within the scope of the appended claims or the equivalents thereof.

For instance, the binary tree Bt described above is assumed to have a structure in which the branches spread from the top to the bottom, but is not limited thereto, and may be configured such that the branches spread from the bottom to the top, from the left to the right, or from the right to the left. The changes related to such arrangement are realized by simply rotating and arranging the binary tree, and the configurations related to such changes also fall within substantially the same technical scope. The changes for mirror reversing the horizontal coordinate axis for forming the temporary directed graph and the directed graph also fall within the technical scope.

The key distribution server 102 according to each embodiment includes components for generating the directed graph on its own, but is not limited thereto. The key distribution server 102 according to the embodiment of the present invention may include an acquiring unit for acquiring information related to a predetermined directed graph, in which case some of or all of the tree structure setting unit 104, the coordinate axis setting unit 106, the temporary directed graph generation unit 108, and the directed graph generation unit 110 may not be arranged.

The key distribution server 102 according to each embodiment above includes the communication unit 118 for distributing content, content key, set key, intermediate key, information of subset corresponding to the permitted contractor, information of directed graph, or the like to the terminal device 122, but the network is not necessarily used at all times to provide such information. The key distribution server 102 may include a recording unit for recording information on a recording medium in place of the communication unit 118.

What is claimed is:

1. An information processing device comprising:
an identifier setting unit for setting an identifier to a set of terminal devices corresponding to each node of a tree structure; and
a key setting unit for setting a key distributed to the terminal device based on the identifier, wherein
the identifier setting unit includes a first identifier indicating the set of terminal devices corresponding to each node, and sets the identifier so as to further include a second identifier showing a correspondence relation between plurality of subsets when the set includes a plurality of subsets.

2. The information processing device according to claim 1, further comprising:
a public information setting unit for setting public information including information of a predetermined multiplicative group, information of bilinear mapping defined by the multiplicative group, and information of a plurality of generators belonging to the multiplicative group, and publicized to the terminal device, wherein
the key setting unit sets a key corresponding to the first identifier and a key corresponding to each subset based on a predetermined parameter including the public information.

3. The information processing device according to claim 2, further comprising:
a path information acquiring unit for acquiring path information defined with a correspondence relationship between each subset for every set based on a predetermined system, and showing a path connecting one subset and another subset according to the correspondence relationship, wherein
the identifier setting unit sets the second identifier based on the path information acquired by the path information acquiring unit.

4. The information processing device according to claim 2, further comprising:
a path information acquiring unit for acquiring path information defined with a correspondence relationship between each subset for every set based on a predetermined system, and showing a path connecting one subset and another subset according to the correspondence relationship; and
a path information changing unit for changing the path information acquired by the path information acquiring unit so that a path length between each subset becomes long, wherein
the identifier setting unit sets the second identifier based on the path information changed by the path information changing unit.

5. The information processing device according to claim 2, further comprising:
a path information acquiring unit for acquiring path information defined with a correspondence relationship between each subset for every set based on a predetermined system, and showing a path connecting one subset and another subset according to the correspondence relationship; and
a path information changing unit for changing the path information acquired by the path information acquiring unit so that a path length between each subset becomes long, and changing the correspondence relationship between the subsets of relatively short path length contained in the changed path information to a correspondence relationship of shorter path length, wherein
the identifier setting unit sets the second identifier based on the path information changed by the path information changing unit.

6. The information processing device according to claim 2, further comprising:
a path information acquiring unit for acquiring path information defined with a correspondence relationship between each subset for every set based on a predetermined system, and showing a path connecting one subset and another subset according to the correspondence relationship; and
a path information changing unit for changing the path information acquired by the path information acquiring unit so that a path length between each subset becomes short, wherein
the identifier setting unit sets the second identifier based on the path information changed by the path information changing unit.

7. A key setting method in a key distribution system including a plurality of terminal devices, comprising the steps of:
setting an identifier to a set of terminal devices corresponding to each node of a tree structure; and
setting a key distributed to the terminal device based on the identifier, wherein
in the identifier setting step, a first identifier indicating the set of terminal devices corresponding to each node is included, and the identifier is set so that a second identifier showing a correspondence relation between plurality of subsets is further included when the set is configured by a plurality of subsets.

8. A program for causing a computer to realize a key setting method in a key distribution system including a plurality of terminal devices, the program causing the computer to realize the functions of:
setting an identifier to a set of terminal devices corresponding to each node of a tree structure such that a first identifier indicating the set of terminal devices corresponding to each node is included, and a second identifier showing a correspondence relation between plurality of subsets is further included when the set is configured by a plurality of subsets; and
setting a key distributed to the terminal device based on the identifier.
